(19) United States
(12) Patent Application Publication
(10) Pub. No.: US 2015/0183991 A1
(43) Pub. Date: Jul. 2, 2015

(54) FLAME-RETARDANT THERMOPLASTIC RESIN COMPOSITION AND MOLDED ARTICLE OF THE SAME

(71) Applicant: ASAHI KASEI CHEMICALS CORPORATION, Tokyo (JP)

(72) Inventors: Mihoko YAMAMOTO, Tokyo (JP); Koichiro YOSHIDA, Tokyo (JP); Shunichiro I, Tokyo (JP); Chihiro MAEDA, Tokyo (JP)

(73) Assignee: ASAHI KASEI CHEMICALS CORPORATION, Tokyo (JP)

(21) Appl. No.: 14/546,329

(22) Filed: Nov. 18, 2014

(30) Foreign Application Priority Data
Nov. 20, 2013 (JP) 2013-239931

(51) Int. Cl. C08L 77/06

(52) U.S. Cl. CPC C08L 77/06; C08L 2205/03; C08L 2205/035

(57) ABSTRACT

Provided is a flame-retardant thermoplastic resin composition including (A) a thermoplastic resin other than a polyphenylene ether, (B) polyphenylene ether, (C) at least one phosphinate selected from the group consisting of a phosphinate having a particular structure, a diphosphinate having a particular structure and a condensate thereof, and (D) at least one colorant selected from the group consisting of an organic pigment, an inorganic pigment and an organic dye, wherein a content of an iron element is less than 50 ppm on a mass basis.

### TECHNICAL FIELD

The present invention relates to a flame-retardant thermoplastic resin composition and a molded article of the same.

### BACKGROUND ART

A polyphenylene ether-based resin composition based on polyphenylene ether is expected to be excellent in characteristics such as heat resistance, electrical characteristics, dimensional stability, impact resistance, acid resistance, alkaline resistance, low water-absorbing property and low specific gravity, and various developments are performed.

Polyphenylene ether can be alloyed with various thermoplastic resins. For example, it is tried to be alloyed with a polystyrene-based resin, a polyamide-based resin, a polyolefin-based resin, a phenylene sulfide-based resin, polyester, or the like.

Among them, for example, a polyamide-based resin is excellent in, for example, mechanical strength, heat resistance and chemical resistance, and thus is used in many fields of automobile components, mechanical components, electric and electronic components, and the like. In particular, polyamide 6,6 or the like is used as a material for a relay block disposed in an engine room of an automobile, but has the problem of a large change in dimension in water absorption. Therefore, recently, an alloy of polyphenylene ether and a polyamide-based resin has been increasingly studied as the material for a relay block.

Automobile components, mechanical components, electric and electronic components, and the like have recently tended to be complicated in terms of the shape thereof, and currently are further increasingly demanded to be smaller and thinner. On the other hand, a new demand such as flame retarding also occurs from the viewpoint of prevention of vehicle fire. Such tendencies are particularly remarkable particularly in automobile components such as a relay block.

Example of a conventional method for flame-retarding a polyamide-based resin may include a method of adding a chlorine-substituted polycyclic compound or a brominated flame retardant to polyamide. Example of the brominated flame retardant may include a decarbomodiphenyl ether, brominated polystyrene, brominated polyphenylene ether, a brominated crosslinked aromatic polymer and a brominated styrene-maleic anhydride polymer.

On the other hand, in accordance with an increased interest in environmental problems in recent years, a halogen-free triazine-based flame retardant has attracted attention, and has been studied in large numbers. As such a flame retardant, use of, for example, melamine, cyanuric acid or cyanuric acid melamine has been studied.

In addition, there have also been studied melamine phosphate or melamine pyrophosphate as an intumescent type flame retardant; a halogen-free flame retarding technique in which melamine polyphosphate is used for a glass fiber-reinforced polyamide resin; a flame retarding technique in which melamine polyphosphate or a charred catalyst and/or a char forming agent, and the like are compounded with an inorganic reinforced polyamide resin; a flame retardant combination technique in which phosphate is combined with a reaction product of melamine and phosphoric acid, and the like.

Furthermore, for example, a flame retarding technique has also been studied in which an alloy of polyphenylene ether with a polyamide-based resin and a nitrogen-based compound such as a condensation product of phosphinates with melamine are used. Specifically, there have been proposed, for example, a technique in which the content rate of a phosphinate having a particle size equal to or larger than a particular size, among phosphinates dispersed in an alloy of polyphenylene ether with a polyamide-based resin, is set to a particular range or lower (see, for example Patent Document 1), a technique in which a polyamide-based resin having a particular viscosity number is used (see, for example, Patent Document 2), and a technique in which a step of dry-blending phosphinates with polyphenylene ether to provide a mixture and a step of melting and kneading the mixture are performed for a method for producing an alloy of polyphenylene ether with a polyamide-based resin (see, for example, Patent Document 3). In addition, there has also been proposed, for example, a technique in which a conductive filler, melamine polyphosphate, zinc borate, a low-melting glass, talc, or the like is added as a flame retarding reinforcing agent (see, for example, Patent Document 4).

Patent Document 1: Japanese Patent Laid-Open No. 2007-169309

Patent Document 2: Japanese patent Laid-Open No. 2008-038125

Patent Document 3: Japanese Patent Laid-Open No. 2010-260995

Patent Document 4: Japanese patent Laid-Open (Translation of PCT Application) No. 2009-533523

### SUMMARY OF THE INVENTION

### Problems to be Solved by the Invention

In recent years, however, components for SMT (surface Mount Technology), typified by a relay block, a connector, and the like have increasingly tended to be complicated in shape, and be smaller and thinner, and there have been the problems of a low yield ratio, for example, adhesion of a deposit, called a mold deposit, to a mold for molding in molding, and a rise in surface appearance failures of a molded article, such as occurrence of so-called silver streaks.

When phosphinates are used for a flame retardant, certain flame retardance is achieved even if a thin molded article is formed, but appearance failures tend to be easily caused if coloring is made. Herein, such appearance failures may be caused not only in combination use of phosphinates with a colorant but also in use of no colorant. Such a problem is remarkably caused when a flame retardant such as phosphinates is used in particular in a resin composition including polyphenylene ether and other thermoplastic resin composition.

The present invention has been made in view of the above circumstances, and an object thereof is to provide a flame-retardant thermoplastic resin composition that allows the occurrence of gas in molding process to be suppressed, that enables the occurrence of silver streaks and a mold deposit to be significantly suppressed, that provides a molded article excellent in surface appearance, and also that enables excellent flame retardance to be maintained even if formed into a thin molded article.

### Means for Solving the Problems

The present inventors have made intensive studies in order to solve the above problems, and as a result, have found that a resin composition has a content of an iron element controlled in a particular range to thereby provide a molded article excellent in surface appearance and also enable excellent flame retardance to be maintained even if being formed into a thin molded article, even in the case of using phosphinates, thereby have completed the present invention.

That is, the present invention is as follows.

[1]

A flame-retardant thermoplastic resin composition comprising:

(A) at least one thermoplastic resin selected from a polystyrene-based resin, a polyolefin-based resin, a polyester-based resin, a polyamide-based resin, polyarylene sulfide, polyarylate, polyethersulfone, polyetherimide, polysulfone, polyarylketone and mixtures thereof;
(B) polyphenylene ether;
(C) at least on phosphinate selected from the group consisting of a phosphinate represented by the following general formula (I), a diphosphinate represented by the following general formula (II), and a condensate thereof; and
(D) at least one colorant selected from the group consisting of an organic pigment, an inorganic pigment and an organic dye;
wherein a content of an iron element is less than 50 ppm on a mass basis:

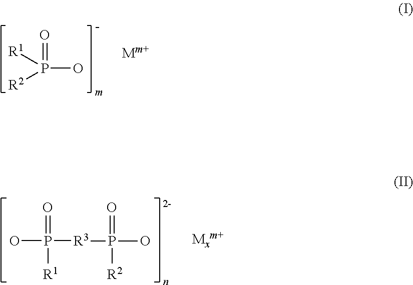

wherein R¹ and R² each independently represent any selected from the group consisting of a straight or branched alkyl group having 1 to 6 carbon atoms, an aryl group and a phenyl group, R³ represents any selected from the group consisting of a straight or branched alkylene group having 1 to 10 carbon atoms, an arylene group having 6 to 10 carbon atoms, an alkylarylene group having 7 to 11 carbon atoms and an arylalkylene group having 8 to 12 carbon atoms, each M independently represents any selected from the group consisting of a calcium ion, a magnesium ion, an aluminum ion, a zinc ion, a bismuth ion, a manganese ion, a sodium ion, a potassium ion and a protonated nitrogen base, each m independently represents 2 or 3, n represents an integer of 1 to 3, and x represents 1 or 2.
[2]
The flame-retardant thermoplastic resin composition according to the above [1], wherein
the component (D) is carbon black, and
a content of the carbon black in the flame-retardant thermoplastic resin composition is from 0.01 to 2% by mass.
[3]

The flame-retardant thermoplastic resin composition according to the above [1] or [2], wherein the content of an iron element in the flame-retardant thermoplastic resin composition is less than 30 ppm on a mass basis.

[4]

The flame-retardant thermoplastic resin composition according to any one of the above [1] to [3], wherein the component (A) is at least one selected from a polyolefin-based resin, a polyester-based resin, a polyamide-based resin, polyarylene sulfide, polyetherimide, polyethersulfone, polysulfone, polyarylketone and mixtures thereof, and the composition further comprises (E) a compatibilizing agent of the component (A) and the component (B).

[5]

The flame-retardant thermoplastic resin composition according to any one of the above [1] to [4], wherein the component (A) is a polyamide-based resin.

[6]

The flame-retardant thermoplastic resin composition according to the above [5], wherein a content of the component (A) is from 25 to 60% by mass based on a total amount of 100% by mass of the component (A) and the component (B).

[7]

The flame-retardant thermoplastic resin composition according to the above [5] or [6], wherein the component (A) contains a semi-aromatic polyamide.

[8]

The flame-retardant thermoplastic resin composition according to any one of the above [5] to [7], wherein the component (A) is (a1) a semi-aromatic polyamide comprising from 70 to 95% by mass of a hexamethylene adipamide unit and from 5 to 30% by mass of a hexamethylene isophthalamide unit.

[9]

The flame-retardant thermoplastic resin composition according to any one of the above [1] to [8], further comprising (F) an impact resistant agent.

[10]

The flame-retardant thermoplastic resin composition according to the above [9], wherein the component (F) is a block copolymer comprising at least one block mainly having an aromatic vinyl compound and at least one block mainly having a conjugate diene compound, and/or a hydrogenated product of the block copolymer.

[11]

The flame-retardant thermoplastic resin composition according to the above [10], wherein a number average molecular weight of the component (F) is 150000 or more.

[12]

The flame-retardant thermoplastic resin composition according to any one of the above [1] to [11], wherein a reduced viscosity of the component (B) is 0.35 dL/g or more.

[13]

The flame-retardant thermoplastic resin composition according to any one of the above [9] to [12], wherein the component (A) is a polyamide-based resin, the component (E) is maleic anhydride and/or maleic acid, and

the component (F) is a hydrogenated styrene-ethylene-butylene copolymer and/or a hydrogenated styrene-isobutylene-styrene copolymer.
[14]

The flame-retardant thermoplastic resin composition according to any one of the above [9] to [12], wherein the component (A) is a polystyrene-based resin, and the component (F) is a hydrogenated styrene-ethylene-butylene copolymer.

[15]

The flame-retardant thermoplastic resin composition according to the above [9] or [12], wherein the component (A) is a polypropylene-based resin, the component (E) is a hydrogenated styrene-ethylene-butylene copolymer, and

the component (F) is a polyolefin-based elastomer.
[16]

the flame-retardant thermoplastic resin composition according to the above [9] or [12], wherein the component (A) is polyphenylene sulfide and/or polybutylene terephthalate,

the component (E) is an epoxy group and/or oxazolyl group-containing polystyrene-based polymer, and the component (F) is a polyolefin-based elastomer.
[17]

A molded article comprising the flame-retardant thermoplastic resin composition according to any one of the above [1] to [16].

[18]

the molded article according to the above [17], wherein the molded article is a relay block.

[19]

The molded article according to the above [17] or [18], wherein a number average particle size of the component (C) comprised in the molded article is from 10 to 35 μm.

### Advantageous Effects of the Invention

The present invention can provide a flame-retardant thermoplastic resin composition that allows the occurrence of gas in molding process to the suppressed, that enable the occurrence of silver streaks and a mold deposit to be significantly suppressed, that provides a molded article excellent in surface appearance, and also that enable excellent flame retardance to be maintained even if formed into a thin molded article.

### BRIEF DESCRIPTION OF DRAWINGS

FIG. 1 shows a schematic plan view of a molded article of a resin composition, used for evaluations of appearance characteristics in Examples.

### MODES FOR CARRYING OUT THE INVENTION

Hereinafter, an embodiment for carrying out the present invention (hereinafter, referred to as “the present embodiment”) is described in detail. The following present embodiment is illustrative for describing the present invention, and is not intended to limit the present invention to the following content. The present invention can be carried out within the gist thereof with being appropriately modified. In the drawing, the same reference symbol is given to the same element, with overlapping description appropriately omitted. In addition, positional relationship, such as top, bottom, left, and right, is based on the positional relationship illustrated in the drawing, unless otherwise specified. Furthermore, the dimensional ratio in the drawing is not limited to the ratio illustrated.

### Flame-Retardant Thermoplastic Resin Composition

A flame-retardant thermoplastic resin composition of the present embodiment is
(A) at least one thermoplastic resin selected from a polystyrene-based resin, a polyolefin-based resin, a polyester-based resin, a polyamide-based resin, polyarylene sulfide, polyarylate, polyethersulfone, polyetherimide, polysulfone, polyarylketone and mixtures thereof;
(B) polyphenylene ether;
(C) at least one phosphinate selected from the group consisting of a phosphinate represented by the following general formula (I), a diphosphinate represented by the following general formula (II), and a condensate thereof; and
(D) at least one colorant selected from the group consisting of an organic pigment, an inorganic pigment and an organic dye;
   wherein the content of an iron element is less than 50 ppm on a mass basis:

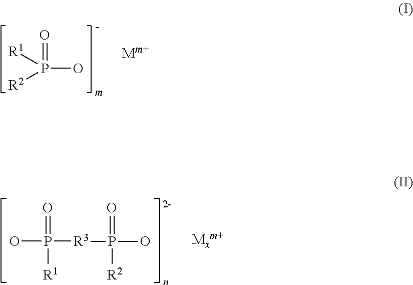

wherein R¹ and R² each independently represent any selected from the group consisting of a straight or branched alkyl group having 1 to 6 carbon atoms, an aryl group and a phenyl group, R³ represents any selected from the group consisting of a straight or branched alkylene group having 1 to 10 carbon atoms, an arylene group having 6 to 10 carbon atoms, an alkylarylene group having 7 to 11 carbon atoms and an arylalkylene group having 8 to 12 carbon atoms, each M independently represents any selected from the group consisting of a calcium ion, a magnesium ion, an aluminum ion, a zinc ion, a bismuth ion, a manganese ion, a sodium ion, a potassium ion and a protonated nitrogen base, each m independently represents 2 or 3, n represents an integer of 1 to 3, and x represents 1 or 2.

The present inventors have made intensive studies, and as a result, have considered that the flame retardant contained in the resin composition is thermally decomposed to thereby generate gas, the gas causes appearance failures, and thermal decomposition of the flame retardant results in the deterioration in flame retardance. The present inventors have advanced further intensive studies in view of such a consideration, and surprisingly have found that the resin composition has a content of an iron element controlled to a particular proportion to thereby provide a molded article excellent in surface appearance and also enable excellent flame retardance to be maintained even if formed into a thin molded article, even in the case of using phosphinates, thereby have completed the present invention.

### Component (A)

The component (A) may be at least one thermoplastic resin selected from a polystyrene-based resin, a polyolefin-based resin, a polyester-based resin (polybutylene terephthalate, polypropylene terephthalate, and liquid crystal polyesters), a polyamide-based resin, polyarylene sulfide, polyarylate, polyethersulfone, polyetherimide, polysulfone, polyarylketone and mixtures thereof. These may be used singly or in combination of two or more.

### Polystyrene-Based Resin

Preferable specific examples of the polystyrene-based resin may include homopolystyrene, a rubber-modified polystyrene (examples may include “high impact polystyrene (HIPS)”); a styrene-based elastomer (examples may include a styrene-butadiene block copolymer and/or a hydrogenated product thereof, and a styrene-isoprene block copolymer and/or a hydrogenated product thereof); and a copolymer of styrene, and a vinyl monomer radical-copolymerizable with styrene.

Specific examples of the vinyl monomer radical-copolymerizable with styrene may include vinyl cyanide compounds such as acrylonitrile and methacrylonitrile; vinylcarboxylic acids and esters thereof, such as acrylic acid, butyl acrylate, methacrylic acid, methyl methacrylate and ethylhexyl methacrylate; unsaturated dicarboxylic anhydrides and derivatives thereof, such as maleic anhydride and N-phenylmaleimide; and diene compounds such as butadiene and isoprene. These may be used singly or in combination of two or more.

Among the above, as a specific example of the polystyrene-based resin, homopolystyrene, a rubber-modified polystyrene, an acrylonitrile-styrene copolymer, a copolymer of N-phenylmaleimide and styrene, and mixtures thereof are more preferable.

The reduced viscosity (measured at 30° C. in a toluene solution in a concentration of 0.5 g/100 mL) of the polystyrene-based resin (A) is not particularly limited, but is preferably 0.5 to 2.0 dL/g. The lower limit of the reduced viscosity is more preferably 0.7 dL/g or more, further preferably 0.8 dL/g or more. The upper limit of the reduced viscosity is more preferably 1.5 dL/g of less, further preferably 1.2 dL/g or less. When the reduced viscosity falls within the above range, surface appearance can be superior with excellent flame retardance being maintained.

### Polyolefin-Based Resin

The polyolefin-based resin is not particularly limited, and examples thereof may include polyethylene, polypropylene, an olefin-based elastomer (copolymer of ethylene and α-olefin), and a copolymer of ethylene and acrylates. Among them, polypropylene (hereinafter, abbreviated as “PP”), and a polyolefin-based elastomer are preferable. These may be used singly or in combinations of two or more.

As PP, for example, (i) a crystalline propylene homopolymer, and (ii) a crystalline propylene-ethylene block copolymer having a crystalline propylene homopolymer moiety obtained in a first step of polymerization and propylene-ethylene random copolymer moiety obtained by copolymerization of propylene, ethylene and/or at least another α-olefin (examples may include butene-1 and hexene-1) in second and subsequent steps of polymerization are preferable. Furthermore, PP may be a mixture of such a crystalline propylene homopolymer and a crystalline propylene-ethylene block copolymer.

PP can be usually obtained by polymerizing the above-mentioned monomer in the presence of a titanium trichloride catalyst or a titanium halide catalyst supported on a carrier such as magnesium chloride and an alkylaluminum compound in the polymerization temperature range from 0 to 100° C. and the polymerization pressure range from 3 to 100 atm. Here, a chain transfer agent such as hydrogen may be added in order to adjust the molecular weight of the polymer. The polymerization method may be any method of a batch-based method and a continuous method. Any method such as a solution polymerization method in a solvent such as butane, pentane, hexane, heptane or octane; a slurry polymerization method; a bulk polymerization method in a monomer in the absence of a solvent; and a gas phase polymerization method in a gaseous monomer can be adopted if necessary.

As other component, an electron donating compound can also be used as an internal donor component or an external donor component in order to enhance isotacticity and polymerization activity of PP. As the electron donating compound, a known electron dontaing compound can be used, and examples may include ester compounds such as ε-caprolactone, methyl methacrylate, ethyl benzoate and methyl toluate; phosphites such as triphenyl phosphite and tributyl phosphite; and phosphoric acid derivatives such as hexamethylphosphoric triamide. Furthermore, examples may include alkoxyester compounds, aromatic monocarboxylates, aromatic alkylalkoxysilanes, aliphatic hydrocarbon alkoxysilanes, various ether compounds, various alcohols and various phenols. These may be used singly or in combinations of two or more.

The density of the propylene polymer moiety in PP is preferably 0.90 g/cm³ or more, more preferably 0.90 to 0.93 g/cm³, further preferably 0.90 to 0.92 g/cm³. The density of the propylene polymer moiety can be determined by the underwater substitution method according to JIS K-7112. When PP is a copolymer with α-olefin, mainly having propylene, a copolymerizing component is extracted from such a copolymer by using a solvent such as hexane, and the density of the remaining propylene polymer moiety can be determined by the underwater substitution method according to JIS K-7112.

In the present embodiment, a crystal nucleating agent is preferably added to PP to increase the density of PP. The crystal nucleating agent is not particularly limited as long as it results in the enhancement in crystallinity of PP, and examples thereof may include organic nucleating agents such as metal salt of an aromatic carboxylic acid, a sorbitol-based derivative, an organic phosphate and an aromatic amide compound; and inorganic nucleating agents such as talc.

The melt flow rate of PP (MFR; measured at a temperature of 230° c. and at a load of 2.16 kgf according to JIS K-6758) is preferably 10 g/10 min or more, more preferably 20 to 50 g/10 min, further preferably 25 to 40 g/10 min, further more preferably 30 to 40 g/10 min.

The copolymer of ethylene and α-olefin (hereinafter, sometimes abbreviated as “ethylene/α-olefin copolymer”) is preferably a copolymer of ethylene and at least one α-olefin having 3 to 20 carbon atoms. Specific examples of the α-olefin having 3 to 20 carbon atoms may include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosen, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-pentene, 11-methyl-1-dodecene, 12-ethyl-1-tetradecene and combinations thereof. These may be used singly or in combinations of two or more. Among them, a copolymer of ethylene and α-olefin having 3 to 12 carbon atoms is more preferable. The content of α-olefin in the ethylene/α-olefin-based copolymer is preferably 1 to 30 mol %, more preferably 2 to 25 mol %, further preferably 3 to 20 mol %, based on the total amount of the monomer.

The ethylene/α-olefin copolymer may be a terpolymer of ethylene, α-olefin and other unconjugated diene. Examples of the unconjugated diene may include 1,4-hexadiene, dicyclopentadiene, 2,5-norbornadiene, 5-ethylidene norbornene, 5-ethyl-2,5-norbornadiene and 5-(1′-propenyl)-2-norbornene. These may be used singly or in combinations of two or more.

In the present embodiment, for example, an ethylene/α-olefin copolymer having a functional group, obtained by further reacting the above ethylene/α-olefin copolymer with an unsaturated compound having a functional group (examples may include a carboxylic group, an acid anhydride group, an ester group and a hydroxyl group); a copolymer of ethylene and a functional group-containing (for example, a functional group such as an epoxy group, a carboxylic group, an acid anhydride group, an ester group or a hydroxyl group) monomer; and a copolymer of an ethylene/α-olefin/functional group-containing monomer can also be used.

### Polyester-Based Resin

Specific examples of the polyester-based resin may include polybutylene terephthalate, polypropylene terephthalate, polyethylene terephthalate, polyethylene naphthalate, polybutylene naphthalate, polypropylene naphthalate and a liquid crystal polyester. These may be used singly or in combinations of two or more. Among them, polybutylene terephthalate and a liquid crystal polyester are more preferable.

As the liquid crystal polyester, for example, a polyester called a thermotropic liquid crystal polymer, and a known one can be used. Examples may include a thermotropic liquid crystal polyester having p-hydroxybenzoic acid and polyethylene terephthalate as main structural units; a thermotropic liquid crystal polyester having p-hydroxybenzoic acid and 2-hydroxy-6-naphthoic acid as main structural units; and a thermotropic liquid crystal polyester having p-hydroxybenzoic acid, 4,4′-dihydroxybiphenyl and terephthalic acid as main structural units. The main structural unit used here means a structural unit whose content is preferably 50 mol % or more, more preferably 70 mol % or more, further preferably 90 mol % or more, based on the total amount of the monomer.

### Polyamide-Based Resin

Any resin may be used as the polyamide-based resin as long as it has an amide bond {—NH—C(═O)—} in the repeating unit of the main chain of a polymer, and the kind thereof is not particularly limited. The polyamide-based resin can be usually obtained by ring-opening polymerization of lactams, polycondensation of diamine and dicarboxylic acid, polycondensation of aminocarboxylic acid, or the like, but the method for producing the polyamide-based resin is not limited thereto, and the polyamide-based resin may be a polyamide-based resin obtained by other methods.

The diamine may include an aliphatic diamine, an alicyclic diamine and an aromatic diamine. Specific examples of the diamine include aliphatic diamines such as tetramethylenediamine, hexamethylenediamine, undecamethylenediamine, dodecamethylenediamine, tridecamethylenediamine, 2,2,4-trimethylhexamethylenediamine, 2,4,4-trimethylhexamethylenediamine, 5-methylnonamethylenediamine, 1,9-nonanediamine, 2-methyl-1,8-octanediamine, ethylenediamine, propylenediamine, 1,4-butanediamine, 1,6-hexanediamine, 1,8-octanediamine, 1,10-decanediamine, 1,12-dodecanediamine, 3-methyl-1,5-pentanediamine, 2,2,4-trimethyl-1,6-hexanediamine, 2,4,4-trimethyl-1,6-hexanediamine and 5-methyl-1,9-nonanediamine; alicyclic diamines such as 1,3-bisamineomethylcyclohexane and 1,4-bisaminomethylcyclohexane; aromatic diamines such as m-phenylenediamine, p-phenylenediamine, m-xylylenediamine and p-xylylenediamine.

The dicarboxylic acid may include an aliphatic dicarboxylic acid, an alicyclic dicarboxylic acid and an aromatic dicarboxylic acid. Specific examples of the dicarboxylic acid may include aliphatic dicarboxylic acids such as adipic acid, suberic acid, azelaic acid, sebacic acid and dodecanedioic acid; alicyclic dicarboxylic acids such as 1,1,3-tridecanedioic acid and 1,3-cyclohexanedicarboxylic acid; and aromatic dicarboxylic acids such as terephthalic acid, isophthalic acid, naphthalenedicarboxylic acid and dimer acid.

Examples of the lactams may include ε-caprolactam, ω-enantholactam and ω-laurolactam.

Examples of the aminocarboxylic acid may include ε-aminocarproic acid, 7-aminoheptanoic acid, 8-aminooctanoic acid, 9-aminononanoic acid, 11-aminoundecanoic acid, 12-aminododecanoic acid and 13-aminotridecanoic acid.

The diamine, dicarboxylic acid, lactams, and aminocarboxylic acid may be each used singly or in combinations of two or more. In addition, each of the diamine, dicarboxylic acid, lactams, aminocarboxylic acid, and the like can also be used with being polymerized to a low molecular weight oligomer in a polymerization reactor and then to a polymer in an extruder or the like.

Examples of the polyamide-based resin may include polyamide 6, polyamide 6,6, polyamide 4,6, polyamide 11, polyamide 12, polyamide 6,10, polyamide 6,12, polyamide 6/6,6, polyamide 6/6,I2, polyamide MXD (m-xylylenediamine), 6, polyamide 6, T, polyamide 9T, polyamide 6,I, polyamide 6,6/6,T, polyamide 6/6,I, polyamide 6,6/6T, polyamide 66/6, I, polyamide 6/6,T/6, I, polaymide 6,6/6, T/6,I, polaymide 6/12/6,T, polyamide 6,6/12/6,T, polyamide 6/12/6,I and polyamide 6,6/12/6,I.

The polyamide-based resin preferably contains a semi-aromatic polyamide from the viewpoints of heat resistance and dimensional stability of a molded article in water absorption. The semi-aromatic polyamide refers to a polymer including a dicarboxylic acid unit (a) and a diamine unit (b), in which at least a part of any one of the dicarboxylic acid unit (a) and the diamine unit (b) is an aromatic compound. As the semi-aromatic polyamide, a semi-aromatic polyamide described below in detail is preferably used.

From the viewpoints of flame retardance and heat resistance, the semi-aromatic polyamide preferably contains a terephthalic acid unit as the dicarboxylic acid unit (a). The content of the terephthalic acid unit in the dicarboxylic acid unit (a) is preferably 60 to 100 mol %, more preferably 75 to 100 mol %, further preferably 90 to 100 mol %, and further more preferably, almost all the dicarboxylic acid unit (a) is a terephthalic acid unit.

The content of a dicarboxylic acid unit other than the terephthalic acid unit in the dicarboxylic acid unit (a) of the semi-aromatic polyamide is preferably less than 40 mol %, more preferably less than 25 mol %, further preferably less than 10 mol %, and further more preferably, such a dicarboxylic acid unit is not substantially contained.

Examples of the dicarboxylic acid unit other than the terephthalic acid unit may include units derived from aliphatic dicarboxylic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; units derived from alicyclic dicarboxylic acids such as 1,3-cyclopentanedicarboxylic acid and 1,4-cyclohexanedicarboxylic acid; and units derived from aromatic dicarboxylic acids such as isophthalic acid, 2,6-naphthalenedicarboxylic acid, 2,7-naphthalenedicarboxylic acid, 1,4-naphthalenedicarboxylic acid, 1,4-phenylenedioxydiacetic acid, 1,3-phenylenedioxydiacetic acid, diphenic acid, diphenylmethane-4,4′-dicarboxylic acid, diphenylsulfone-4,4′-dicarboxylic acid, 4,4′-biphenyldicarboxylic acid. These may be used singly or in combinations of two or more. In addition, units derived from aromatic dicarboxylic acids are preferable. Furthermore, a unit derived from a tri- or higher polyvalent carboxylic acid such as trimellitic acid, trimesic acid or pyromellitic acid may be included to such an extent that melt-molding can be performed.

From the viewpoint of dimensional stability of a molded article in water absorption, the semi-aromatic polyamide preferably contains a 1,9-nonamethylenediamine unit (b-1) and/or a 2-methyl-1,8-octamethylenediamine unit (b-2) as the diamine unit (b).

The total content of the 1,9-nonamethylenediamine unit (b-1) and the 2-methyl-1,8-octamethylenediamine unit (b-2) in the diamine unit (b) is preferably 60 to 100 mol %, more preferably 75 to 100 mol %, further preferably 90 to 100 mol %, and further more preferably, substantially all the diamine units are configured from the 1,9-nonamethylenediamine unit (b-1) and/or the 2-methyl-1,8-octamethylenediamine unit (b-2).

The content of a diamine unit other than the 1,9-nonamethylenediamine unit and the 2-methyl-1,8-octamethylenediamine unit in the diamine unit (b) in the semi-aromatic polyamide is preferably less than 40 mol %, more preferably less than 25 mol %, further preferably less than 10 mol %, and further more preferably, such a diamine unit is not substantially contained.

Examples of the diamine unit other than the 1,9-nonamethylenediamine unit and the 2-methyl-1,8-octamethylenediamine unit may include units derived from aliphatic diamines such as ethylenediamine, propylenediamine, 1,4-butanediamine, 1,6-hexanediamine, 1,8-octamethylenediamine, 1,10-decanediamine, 1,12-dodecanediamine, 3-methyl-1,5-pentanediamine, 2,2,4-trimethyl-1,6-hexanediamine, 2,4,4-trimethyl-1,6-hexanediamine and 5-methyl-1,9-nonamethylenediamine; units derived from alicyclic diamines such as cyclohexanediamine, methylcyclohexanediamine and isophoronediamine; and units derived from aromatic diamines such as p-phenylenediamine, m-phenylenediamine, xylylenediamine, 4,4′-diaminodiphenylmethane, 4,4′-diaminodiphenylsulfone and 4,4′-diaminodiphenyl ether. These may be used singly or in combinations of two or more.

When the total amount of the 1,9-nonamethylenediamine unit (b-1) and the 2-methyl-1,8-octamethylenediamine unit (b-2) in the diamine unit (b) contained in the semi-aromatic polyamide is assumed to be 100 mol %, the lower limit of the content of the 1,9-nonamethylenediamine unit (b-1) is preferably 60 mol % or more, more preferably 75 mol % or more, further preferably 80 mol % or more. When the lower limit of the content of the unit (b-1) falls within the above range, heat resistance can be further enhanced and water-absorbing property of a molded article can be further effectively suppressed. When the total amount of the unit (b-1) and the unit (b-2) in the diamine unit (b) is assumed to be 100 mol %, the upper limit of the content of the unit (b-1) is preferably 95 mol % or less, more preferably 90 mol % or less, further preferably 85 mol % or less. When the upper limit of the content of the unit (b-1) falls within the above range, mechanical characteristics such as impact resistance and tensile elongation can be further enhanced and surface appearance of a molded article can be superior.

As the polyamide-based resin, a polyamide-based resin obtained by copolymerizing a plurality of polyamide-based resins by an extruder or the like can also be used. For such a polyamide-based resin, an aliphatic polyamide such as polyamide 6, polyamide 6,6, polyamide 4,6, polyamide 11 or polyamide 12; or a semi-aromatic polyamide such as polyamide 9, T, polyamide 6/6,T, polyamide 6,6/6, T, polyamide 6,6/6, I or polyamide MXD, 6 is preferable, and polyamide 6,6, polyamide 6, polyamide 9, T, polyamide 6,6/6, I, or the like is more preferable. These may be used singly or in combination of two or more.

The viscosity number (viscosity number measured in 96% sulfuric acid according to ISO 307:1994) of the polyamide-based resin is preferably 50 to 250 mL/g. The lower limit of the viscosity number is more preferably 70 mL/g or more, further preferably 100 mL/g or more. The upper limit of the viscosity number is more preferably 200 mL/g or less, further preferably 150 mL/g or less.

When the viscosity number of the polyamide-based resin is the above lower limit or more, processabilities such as flame retardance and extrusion are further enhanced and generation of gas in molding is further suppressed. Additionally, when the viscosity number is the above lower limit or more, generation of a mold deposit can be reduced and the number of shots for which normal molding can be performed in injection molding can be drastically increased, leading to a significant improvement in moldability. In addition, when the viscosity number is the above upper limit or less, not only the above-described effect but also the effect of enhancing moldability of a thin molded article can be exerted.

When a polyamide-based resin in which the viscosity number falls within the above range is used, a superior effect is expected to be exerted, but, when a further superior effect is desired, the viscosity number is further preferably controlled as described below depending on the kind of the polyamide-based resin.

For example, when a semi-aromatic polyamide such as polyamide 9T or polyamide 6,6/6,I is used for the polyamide-based resin, a suitable viscosity range thereof is slightly different from the case where no semi-aromatic polyamide is used for the polyamide-based resin, from the viewpoint of the balance between toughness and molding fluidity. With respect to a suitable range of the viscosity number, when polyamide 9,T is used, a preferable lower limit is 70 mL/g or more, and a more preferable lower limit is 100 mL/g or more. In addition, the upper limit of the viscosity number is preferably 150 mL/g or less, and a more preferable upper limit is 120 mL/g or less.

When polyamide 6,6/6,I is used, a preferable lower limit of the viscosity number is 50 mL/g or more, and a more preferable lower limit is 70 mL/g or more. In addition, the upper limit of the viscosity number is preferably 150 mL/g or less, more preferably 130 mL/g or less, further preferably 120 mL/g or less.

The present inventors have found that when the polyamide-based resin is used as the component (B), the balance between moldability and impact resistance of the flame-retardant thermoplastic resin composition is considerably affected by the viscosity number of the polyamide-based resin. From such a viewpoint, a polyamide-based resin in which the viscosity number falls within the above range is used to thereby specifically improve characteristics.

The polyamide-based resin may be a mixture of a plurality of polyamide-based resins having a different viscosity number. The viscosity number of the polyamide-based resin in the flame-retardant thermoplastic resin composition of the present embodiment can be confirmed by the following method.

First, a resin content of the flame-retardant thermoplastic resin composition is dissolved using 1,1,1,3,3,3-hexafluoro-2-propanol, and thereafter the resin content included in a soluble fraction is precipitated with methanol and fractionated. This fractionated product is dissolved by formic acid or sulfuric acid, and thereafter a soluble fraction is fractionated using a centrifuge machine or the like. This soluble fraction is subjected to re-precipitation with methanol to fractionate a polyamide-based resin component, and thereafter, the viscosity number can be measured and confirmed.

From the viewpoints of dimensional stability of a molded article in water absorption and surface appearance of a molded article, the polyamide-based resin is preferably made of a semi-aromatic polyamide configured from 70 to 95% by mass of a hexamethylene adipamide unit and 5 to 30% by mass of a hexamethylene isophthalamide unit. Herein, hexamethylene adipamide can be obtained from, for example, adipic acid and hexamethylenediamine. Hexamethylene isophthalamide can be obtained from, for example, isophthalic acid and hexamethylenediamine.

The terminal groups of the polyamide-based resin included in the flame-retardant thermoplastic resin composition of the present embodiment involve in a reaction with the polyphenylene ether (B), described below. The polyamide-based resin usually has an amino group and a carboxyl group as the terminal groups. In general, when the concentration of the terminal carboxyl group is increased, impact resistance tends to be deteriorated and fluidity tends to be enhanced. In general, when the concentration of the terminal amino group is increased, impact resistance tends to be enhanced and fluidity tends to be deteriorated (the effects of the present embodiment, however, are not limited thereto).

From the viewpoint that characteristics of the flame-retardant thermoplastic resin composition of the present embodiment are more favorably balanced, the concentration ratio (molar ratio) of terminal amino group/terminal carboxyl group in the polyamide-based resin is preferably 1.0 or less, more preferably 0.05 to 0.8. When the concentration ratio of terminal amino group/terminal carboxyl group in the polyamide-based resin falls within the above range, the balance between fluidity and impact resistance of the flame-retardant thermoplastic resin composition can be maintained at a higher level.

The concentration of the terminal amino group in the polyamide-based resin is preferably 1 to 80 μmol/g, more preferably 5 to 60 μmol/g, further preferably 10 to 45 μmol/g, further more preferably 20 to 40 μmol/g. When the concentration of the terminal amino group falls within the above range, the balance between fluidity and impact resistance of the flame-retardant thermoplastic resin composition of the present embodiment can be maintained at a higher level.

The concentration of the terminal carboxyl group in the polaymide-based resin is preferably 20 to 150 μmol/g, more preferably 30 to 130 μmol/g. When the concentration of the terminal carboxyl group falls within the above range, the balance between fluidity and impact resistance of the flame-retardant thermoplastic resin composition of the present embodiment can be maintained at a higher level.

The concentration of each of the terminal groups of such a polyamide-based resin can be adjusted using a known method. Examples of the method may include a method of adding one or more selected from a diamine compound, a monoamine compound, a dicarboxylic acid compound, a monocarboxylic acid compound and the like in order to achieve a predetermined concentration of each of the terminal groups in polymerization of the polaymide-based resin.

The concentration of the terminal amino group and the concentration of the terminal carboxyl group can be measured by various methods. For example, a method in which the concentration are determined by the integral value of a characteristic signal corresponding to each of the terminal groups by ¹H-NMR is preferable from the viewpoint of accuracy and simplicity. Specific examples of a method for quantitatively measuring the concentration of each of the terminal groups of the polyamide-based resin may include the method described in Examples of Japanese Patent Laid-Open No. 07-228689. Specifically, the number of each of the terminal groups is preferably determined by the integral value of a characteristic signal corresponding to each of the terminal groups by ¹H-NMR (measured at 500 MHz and 50° C. in deuterated trifluoroacetic acid), from the viewpoint of accuracy and simplicity. When the characteristic signal of a terminal sealed by a terminal sealing agent cannot be identified, the limiting viscosity [η] of the polyamide-based resin can be measured to calculate the total number of the terminal groups of the molecular chain using a relationship of the following expression. Mn=21900 [η]−7900 (Mn represents a number average molecular weight)

Total number of terminal groups in molecular chain (eq/g)=2/Mn

It is preferable that 10 to 95% of the terminal groups of the molecular chain of the polyamide-based resin be sealed by the terminal sealing agent. The lower limit of the proportion of the terminal groups sealed (terminal-sealing rate), of the molecular chain of the polyamide-based resin, is more preferably 40% or more, further preferably 60% or more. When the lower limit of the terminal-sealing rate is the above lower limit or more, the change in viscosity of the flame-retardant thermoplastic resin composition of the present embodiment in melt-molding can be more effectively suppressed, and the surface appearance of a molded article to be obtained, the heat-resistance stability in processing, and the like are more enhanced. In addition, the upper limit of the terminal-sealing rate is preferably 95% or less, more preferably 90% or less. When the upper limit of the terminal-sealing rate is the above upper limit or less, impact resistance and surface appearance of a molded article are further enhanced.

The terminal-sealing rate of the polyamide-based resin can be determined according to the following expression (1) by measuring each of the number of the terminal-carboxyl groups, the number of the terminal amino groups, and the number of the terminal groups sealed by the terminal sealing agent, these terminal groups being present in the polyamide-based resin.

Terminal-sealing rate (%)=[(α−β)/α]×100 (1)

wherein α represents the total number of terminal groups in the molecular chain (unit=mol; which is usually equal to twice of the number of polyamide molecules), and β represents the total number of carboxyl group terminals and amino group terminals remaining without being sealed (unit=mol).

The terminal sealing agent is not particularly limited as long as it is a monofunctional compound having a reactivity with the amino group or the carboxyl group at the terminals of the polyamide-based resin, but is preferably monocarboxylic acid or monoamine in terms of reactivity, stability of the terminal sealed, and the like, and is more preferably monocarboxylic acid in terms of easiness of handling and the like. In addition thererto, acid anhydrides, monoisocyanates, monoacid halides, monoesters, monoalcohols, or the like can be used as the terminal sealing agent.

The monocarboxylic acid for use as the terminal sealing agent is not particularly limited as long as it has a reactivity with an amino group, and examples may include aliphatic monocarboxylic acids such as acetic acid, propionic acid, butyric acid, valeric acid, caproic acid, caprylic acid, lauric acid, tridecanoic acid, myristic acid, palmitic acid, stearic acid, pivalic acid and isobutyric acid; alicyclic monocarboxylic acids such as cyclohexanecarboxylic acid; aromatic monocarboxylic acids such as benzoic acid, toluic acid, α-naphthalenecarboxylic acid, β-naphthalenecarboxylic acid, methylinaphthalenecarboxylic acid and phenylacetic acid; and any mixtures thereof. Among them, in terms of reactivity, stability of the terminal sealed, economic efficiency, and the like, acetic acid, propionic acid, butyric acid, valeric acid, caproic acid, caprylic acid, lauric acid, tridecanoic acid, myristic acid, palmitic acid, stearic acid and benzoic acid are preferable, and acetic acid and benzoic acid are more preferable.

The monoamine for use as the terminal sealing agent is not particularly limited as long as it has a reactivity with a carboxyl group, and examples may include aliphatic monoamines such as methylamine, ethylamine, propylamine, butylamine, hexylamine, octylamine, decylamine, stearylamine, dimethylamine, diethylamine, dipropylamine and dibutylamine; alicyclic monoamines such as cyclohexylamine and dicyclohexylamine; aromatic monoamines such as aniline, toluidine, diphenylamine and naphthylamine; and any mixtures thereof. Among them, in terms of reactivity, boiling point, stability of the terminal sealed, economic efficiency, and the like, butylamine, hexylamine, octylamine, decylamine, stearylamine, cyclohexylamine and aniline are preferable, and butylamine, hexylamine and octylamine are more preferable.

For the purpose of further enhancing the heat-resistance stability of the flame-retardant thermoplastic resin composition, not only the polyamide-based resin, but also a transition metal (excluding iron) and halogen may be present in the flame-retardant thermoplastic resin composition.

The transition metal (excluding iron) is not particularly limited in terms of the kind thereof as long as it is a transition metal other than iron, and examples may include copper, cerium, nickel and cobalt. Among them, in terms of heat stability for a long period, copper is preferable. In addition, the kind of halogen is not particularly limited, but bromine and iodine are preferable from the viewpoint of preventing corrosion of production facilities, and the like.

The content of the transition metal (excluding iron) is preferably 1 ppm or more and less than 200 ppm, more preferably 5 ppm or more and less than 100 ppm on a mass basis, based on 100% by mass of the total amount of the flame-retardant thermoplastic resin composition of the present embodiment. In addition, the content of halogen is preferably 500 ppm or more and less than 1500 ppm, more preferably 700 ppm or more and less than 1200 ppm on a mass basis, based on 100% by mass of the total amount of the flame-retardant thermoplastic resin composition of the present embodiment.

The method of adding such a transition metal (excluding iron) and halogen to the flame-retardant thermoplastic resin composition is not particularly limited, and examples may include a method of adding them as powders in a step of melting and kneading the polyamide-based resin, and the polyphenylene ether (B) described later; a method of adding them in polymerization of the polaymide-based resin; and a method including producing a master pellet of the polyamide-based resin to which the transition metal and halogen are added in high concentrations, and then adding the master pellet of the polyamide-based resin to the flame-retardant thermoplastic resin composition. Among these methods, a preferable method is a method of adding in polymerization of the polyamide-based resin, or a method including producing a master pellet of the polyamide-based resin to which the transition metal and/or halogen is added in high concentration(s), and then adding the master pellet.

### Polyarylene Sulfide

Preferable specific examples of the polyarylene sulfide may include polyphenylene sulfide. The polyphenylene sulfide (hereinafter, sometimes abbreviated as “PPS”) is a polymer including a phenylene sulfide repeating unit represented by the following formula (III). The content of this repeating unit in the polyarylene sulfide is preferably 50 mol % or more, more preferably 70 mol % or more, further preferably 90 mol % or more.

[—Ar—S—] (III)

wherein S represents a sulfur atom, Ar represents an arylene group, and examples of the arylene group may include a p-phenylene group, a m-phenylene group, a substituted phenylene group (the substituent is preferably an alkyl group having 1 to 10 carbon atoms, or a phenyl group), a p,p′-diphenylenesulfone group, a p,p′-biphenylene group, a p,p′-diphenylenecarbonyl group, and a naphthylene group.

PPS is a homopolymer formed by only the repeating unit represented by general formula (III), and may be a homopolymer in which Ar in general formula (III) is formed by only one arylene group. In addition, PPS may be a copolymer formed by only the repeating unit represented by general formula (III), in which Ar in general formula (III) is of two or more of different arylene groups, in terms of processability and heat resistance. Among them, PPS preferably having 50 mol % or more of the p-phenylene sulfide repeating unit, more preferably 70 mol % or more, further preferably 90 mol % or more, is preferable because of being excellent in processability and heat resistance, and easily available.

The concentration of chlorine contained in PPS is preferably 1500 ppm or less, more preferably 900 ppm or less from the viewpoint of suppression of corrosion. The concentration of chlorine can be measured according to JPCA-ES01 (halogen-free copper-clad laminate test method) defined by Japan Printed Circuit Association (JPCA). The analysis method can be performed by flask combustion treatment ion chromatography.

The method for producing PPS is not particularly limited, and a known method can also be used. Examples may include a method of polymerizing a halogen-substituted aromatic compound (examples may include p-dichlorobenzene) in the presence of sulfur and sodium carbonate; a method of performing polymerization in a polar solvent in the presence of sodium sulfide or sodium hydrogen sulfide, sodium hydroxide or hydrogen sulfide, and sodium hydroxide or sodium aminoalkanoate; and self-condensation of p-chlorothiophenol. Among them, more specifically, preferable is a method of reacting sodium sulfide with p-dichlorobenzene in an amide-based solvent such as N-methylpyrrolidone or dimethylacetoamide, or in a sulfone-based solvent such as sulfolane. In order to allow the molecular chain to have a branched structure, trichlorobenzene may also be used as a branching agent, if necessary.

PPS can also be obtained by, for example, any of the methods described in U.S. Pat. No. 2,513,188, Japanese Patent Publication No. 44-27671, Japanese Patent Publication No. 45-003368, Japanese Patent Publication No. 52-012240, Japanese patent Laid-Open No. 61-225217, U.S. Pat. No. 3,274,165, Japanese Patent Publication No. 46-027255, Belgian Patent No. 29437 and Japanese Patent Laid-Open No. 05-222196. PPS obtained by such a polymerization reaction is usually linear PPS.

In the present embodiment, PPS may also be used which is obtained by performing a polymerization reaction, and then heat-treating the resultant in the presence of oxygen at a temperature lower than or equal to the melting point of PPS (for example, 200 to 250° C.) to thereby promote oxidation crosslinking, resulting in proper increases in molecular weight and viscosity of a polymer (crosslinked PPS). This crosslinked PPS also encompasses semi-crosslinked PPS in which the degree of crosslinking is controlled lower.

the melt viscosity at 300° C. of PPS at a shearing speed of 100 sec⁻¹ is preferably 10 to 150 Pa·s, more preferably 10 to 100 Pa·s, further preferably 10 to 80 Pa·s. When the melt viscosity falls within the above range, the balance between toughness and rigidity can be maintained at a higher level, and the occurrence of burr in molding can be further effectively suppressed. Herein, the melt viscosity can be measured by a capillary type rheometer. For example, Capilograph (manufactured by Toyo Seiki Seisaku-Sho, Ltd.) and a capillary (capillary length=10 mm, capillary diameter=1 mm) can be used to measure the melt viscosity under conditions of a temperature of 300° C. and a shearing speed of 100 sec⁻¹.

Linear PPS, crosslinked PPS and the like described as specific examples of PPS may be used singly or in combination of two or more. Linear PPS and crosslinked PPS are preferably used in combination for PPS because, in the case of an alloy of PPS and polyphenylene ether, the particle size in a polyphenylene ether dispersion phase can be smaller.

From the viewpoint that whitening and mold deposit in molding are reduced, the content of an oligomer of PPS used is preferably 0.7% by mass or less. The oligomer included in PPS means a substance extracted from PPS by methylene chloride, namely, a substance to be generally treated as impurities of PPS.

The content of the oligomer can be measured by the following method. After 5 g of a powder of PPS is added to 80 mL of methylene chloride and soxhlet extraction is performed for 6 hours, the resultant is cooled to room temperature, and a methylene chloride solution being an extraction liquid is transferred to a weighing bottle. Then, a vessel used for the extraction is washed in three parts with 60 mL of methylene chloride in total, and this washing liquid is added to the extraction liquid in the weighing bottle and recovered. Then, the extraction liquid is heated at about 80° C. to evaporate methylene chloride for removal, and the residue is recovered. The residue is weighed and the amount of this residue is measured, and thus the proportion of the amount of the oligomer extracted by methylene chloride (namely, the amount of the oligomer present in PPS) can be determined.

### Polyarylate

The polyarylene preferable in the present embodiment is a polymer including an aromatic ring and an ester bond as structural units, and is also called a polyaryl ester. As the polyarylate, a polyarylate is preferable which has a repeating unit represented by the following formula (a) and includes bisphenol A and terephthalic acid and/or isophthalic acid. In particular, the molar ratio of terephthalic acid to isophthalic acid is preferably about 1:1 in terms of the balance between heat resistance and toughness.

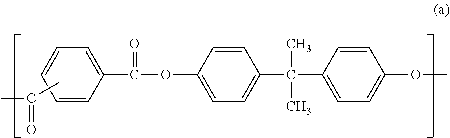

As the polyarylate, a commercial product can also be used. Examples of the commercial product may include a trade name “Upolymer” produced by Unitika Ltd.

The molecular weight of the polyarylate is not particularly limited, but the number average molecular weight in terms of polystyrene measured by gel permeation chromatography (GPC) is preferably 5000 to 300000, more preferably 10000 to 300000, further preferably 10000 to 100000. when the number average molecular weight of the polyarylate is the lower limit or more, heat resistance and mechanical strength are further enhanced. When the number average molecular weight of the polyarylate is the upper limit or less, the fluidity of the flame-retardant thermoplastic resin composition is further enhanced and fine dispersion of a dispersion phase is more easily achieved.

### Polyethersulfone, Polyetherimide, Polysulfone

The polyethersulfone, polyetherimide and polysulfone can be appropriately selected from, for example, known amorphous super engineering plastics. Commercial products can also be used therefor. Examples of the commercial product of the polyethersulfone may include trade names “Radel A (trademark)” and “Radel R (trademark)” produced by Solvay Advanced Polymers, trade name “MITSUI PES” produced by Mitsui Chemicals, Inc., and trade name “Ultrazone E (trademark)” produced by BASF Japan Ltd. Examples of the commercial product of the polyetherimide may include trade name “Ultem (trademark)” produced by Saudi Basic Industries Corporation (SABIC). Examples of the commercial product of the polysulfone may include trade name “Udel (trademark)” and trade name “Mindel (trademark)” produced by Solvay Advanced Polymers, and trade name “Ultrazone S (trademark)” produced by BASF Japan Ltd. These may be used singly or in combinations of two or more.

### Polyarylketone

The polyarylketone includes a resin including an aromatic ring, and an ether bond and a ketone bond as structural units thereof. Specific examples of the polyarylketone may include a polyether ketone, a polyether ether ketone and a polyether ketone. In the present embodiment, in particular, a polyether ether ketone having a repeating unit represented by the following formula (b) is suitably used.

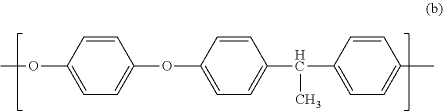

As the polyether ether ketone, a commercial product can also be used. Examples of the commercial product may include trade names “PEEK151G (trademark)”, “PEEK90G (trademark)” and “PEEK381G (trademark)”, “PEEK450G (trademark)”, “PEEK381G (trademark)” produced by VICTREX plc, and trade name “Ultrapek (trademark)” (polyether ketone ether ketone: PEKEKK) produced by BASF Japan Ltd. These may be used singly or in combinations of two or more. Among them, trade name “PEEK (registered trademark)” produced by VICTREX plc is preferable.

The melt viscosity of the polyarylketone is preferably 50 to 5000 Pa·s, more preferably 70 to 3000 Pa·s, further preferably 100 to 2500 Pa·s, further more preferably 200 to 1000 Pa·s. When the melt viscosity of the polyarylketone is the lower limit or more, mechanical strength is further enhanced. When the melt viscosity of the polyarylketone is the upper limit or less, molding processability is further enhanced. The melt viscosity used herein refers to an apparent melt viscosity measured in extruding of a resin to be measured, heated at 400° C., from a nozzle having an inner diameter of 1 mm and a length of 10 mm at a load of 100 kg.

### Component (B)

Examples of the polyphenylene ether (B), but not limited to the following, may include poly (2,6-dimethyl-1,4-phenylene ether), poly (2-methyl-6-ethyl-1,4-phenylene ether), poly (2-methyl-6-phenyl-1,4-phenylene ether) and poly (2,6-dichloro-1,4-phenylene ether). Furthermore, examples also may include polyphenylene ether copolymers such as a copolymer of 2,6-dimethylphenol and other phenols (examples may include a copolymer of 2,6-dimethylphenol and 2,3,6-trimethylphenol and a copolymer of 2,6-dimethylphenol and 2-methyl-6-butylphenol, described in Patent Publication No. 52-017880). Among them, in terms of mechanical strength, poly (2,6-dimethyl-1,4-phenylene ether), a copolymer of 2,6-dimethylphenol and 2,3,6-trimethylphenol, or a mixture thereof is preferable. These may be used singly or in combinations of two or more.

The method for producing the polyphenylene ether (B) is not particularly limited, and a known method can also be adopted. Examples thereof may include the methods described in U.S. Pat. No. 3,306,874, U.S. Pat. No. 3,306,875, U.S. Pat. No. 3,257,357, U.S. Pat. No. 3,257,358, Japanese Patent Laid-Open No. 50-051197, Patent Publication No. 52-017880, and Japanese Patent Laid-Open No. 63-152628.

The lower limit of the reduced viscosity (measured in a 0.5 g/dL chloroform solution at 30° C. in Ubberlohde viscometer) of the polyphenylene ether (B) is preferably 0.30 dL/g or more, more preferably 0.35 dL/g or more, further preferably 0.38 dL/g or more. The upper limit of the reduced viscosity of the polyphenylene ether is preferably 0.80 dL/g or less, more preferably 0.75 dL/g or less, further preferably 0.55 dL/g or less. A combination of the lower limit and the upper limit of the reduced viscosity of the polyphenylene ether is preferably 0.30 to 0.80 dL/g, more preferably 0.35 to 0.75 dL/g, further preferably 0.38 to 0.55 dL/g. When the reduced viscosity of the polyphenylene ether (B) falls within the above range, impact resistance and heat resistance are further enhanced. The polyphenylene ether (B) may be a mixture of two or more polyphenylene ethers having a different reduced viscosity. The reduced viscosity of the polyphenylene ether (B) can be controlled by the amount of a catalyst in polymerization, production conditions such as a polymerization time, and the like.

In order to stabilize the polyphenylene ether (B), known various stabilizers may be compounded in the flame-retardant thermoplastic resin composition. Examples of the stabilizer may include metal-based stabilizers such as zinc oxide and zinc sulfide; and organic stabilizers such as a hindered phenol-based stabilizer, a phosphorus-based stabilizer and a hindered amine-based stabilizer. The content of the stabilizer is preferably less than 5 parts by mass based on 100 parts by mass of the polyphenylene ether (B).

Furthermore, other additives that can be added to the polyphenylene ether (B), other than the above stabilizers, can be compounded in the flame-retardant thermoplastic resin composition. In this case, the total content of other compounding agents is preferably less than 10 parts by mass based on 100 parts by mass of the polyphenylene ether (B).

When the effect of the present embodiment is aimed to be superior, it is preferable to appropriately select conditions such as the kind of a combination of the thermoplastic resin (A) and the polyphenylene ether (B), and the ratio of the respective components compounded, depending on the kinds of the thermoplastic resin (A) and the like. Hereinafter, one example of such suitable combinations of the components is described.

For example, when the thermoplastic resin (A) is a polystyrene-based resin, the content of the polyphenylene ether (B) is preferably 10 to 90% by mass when the total amount of the thermoplastic resin (A) and the polyphenylene ether (B) is assumed to be 100% by mass. The lower limit of the content of the polyphenylene ether (B) is more preferably 20% by mass or more, further preferably 30% by mass or more. The upper limit of the content of the polyphenylene ether (B) is more preferably 80% by mass or less, further preferably 70% by mass or less, further more preferably 60% by mass or less.

When the thermoplastic resin (A) is one selected from the group consisting of the polyolefin-based resin, the polyester-based resin, the polyarylene sulfide, the polyetherimide, the polyethersulfone, the polysulfone, the polyarylketone and mixtures thereof, the content of the polyphenylene ether (B) is preferably 1 to 70% by mass when the total amount of the thermoplastic resin (A) and the polyphenylene ether (B) is assumed to be 100% by mass. The lower limit of the content of the polyphenylene ether (B) is preferably 5% by mass or more, further preferably 10% by mass or more, further more preferably 15% by mass or more. The upper limit of the content of the polyphenylene ether (B) is preferably 60% by mass or less, further preferably 50% by mass or less, further more preferably 40% by mass or less.

When the thermoplastic resin (A) is the polyamide-based resin, the content of the polyphenylene ether (B) is preferably 25 to 60% by mass, more preferably 30 to 50% by mass, further preferably 30 to 40% by mass, when the total amount of the thermoplastic resin (A) and the polyphenylene ether (B) is assumed to be 100% by mass.

When the ratio of the component (B) compounded to the total of the component (A) and the component (B) falls within the above range, the balance among heat resistance, moldability and impact resistance can be maintained at a higher level. The ratio of the component (B) compounded to the total of the component (A) and the component (B) can be determined by the calibration method with the Fourier transform infrared spectrometer (FT-IR).

A preferable dispersion mode of the polyphenylene ether (B) in the flame-retardant thermoplastic resin composition of the present embodiment is a mode where the polyamide-based resin (A) forms a continuous phase and the polyphenylene ether (B) forms a dispersion phase, in terms of the balance among heat resistance, mechanical strength and moldability. When the average particle size here is measured by a transmission electron microscope at a magnification of 10000, a particle of the polyphenylene ether (B) is preferably present in the form of being dispersed in a dispersion phase where the average particle size is 0.1 to 5 μm. The average particle size of the polyphenylene ether (B) is preferably 0.05 to 3 μm, more preferably 0.1 to 2 μm.

### Component (C)

The flame-retardant thermoplastic resin composition of the present embodiment contains at least one phosphinate selected from the group consisting of a phosphinate (I) represented by the following formula (I), a diphosphinate (II) represented by the following formula (II), and a condensate thereof.

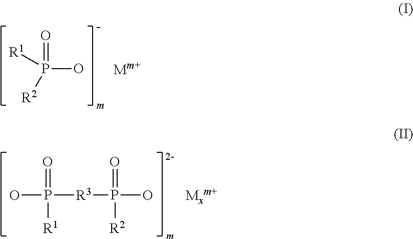

wherein R¹ and R² each independently represent any selected from the group consisting of a straight or branched alkyl group having 1 to 6 carbon atoms, an aryl group and a phenyl group, R² represents any selected from the group consisting of a straight or branched alkylene group having 1 to 10 carbon atoms, an arylene group having 6 to 10 carbon atoms, an alkylarylene group having 7 to 11 carbon atoms and an arylalkylene group having 8 to 12 carbon atoms, each M independently represents any selected from the group consisting of a calcium ion, a magnesium ion, an aluminum ion, a zinc ion, a bismuth ion, a manganese ion, a sodium ion, a potassium ion and a protonated nitrogen base, each m independently represents 2 or 3, n represents an integer of 1 to 3, and x represents 1 or 2.

The phosphinates (C) can be produced in an aqueous solution by using phosphinic acid, a metal carbonate, and a metal hydroxide or a metal oxide, as described in, for example, Japanese Patent Laid-Open No. 2005-179362, EP Publication No. 699708, and Japanese Patent Laid-Open No. 08-073720.

The phosphinates (C) are usually a monomeric compound, but, for example, may include a polymeric phosphinate that is a condensate having a degree of condensation of 1 to 3 depending on reaction conditions and environment. From the viewpoint of further enhancing flame retardance of the flame-retardant thermoplastic resin composition and surface appearance of a molded article, the content of the phosphinate (I) in the component (C) is preferably 90% by mass or more, more preferably 95% by mass or more, further preferably 98% by mass or more.

Examples of the phosphinic acid in general formula (I) and the diphosphinic acid in general formula (II) may include dimethylphosphic acid, ethylmethylphosphinic acid, diethylphosphinic acid, methyl-n-propylphosphinic acid, methanedi (methylphosphinic acid), benzene-1,4-(dimethylphosphinic acid), methylphenylphosphinic acid and diphenylphosphinic acid. These may be used singly or in combinations of two or more.

M^{m+} in general formula (I) and general formula (II) is preferably one or more selected from a calcium ion, a magnesium ion, an aluminum ion and a zinc ion in terms of surface appearance of a molded article.

Specific examples of the phosphinates (C) may include calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate), zince benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate and zinc diphenylphosphinate.

Among them, in terms of flame retardance, and surface appearance of a molded article, calcium dimethylphosphinate, aluminum dimethylphosphinate, zinc dimethylphosphinate, calcium ethylmethylphosphinate, aluminum ethylmethylphosphinate, zinc ethylmethylphosphinate, calcium diethylphosphinate, aluminum diethylphosphinate and zinc diethylphosphinate are preferable, and aluminum diethylphosphinate is more preferable.

The content of the phosphinates (C) in the flame-retardant thermoplastic resin composition of the present embodiment is preferably 1 to 50 parts by mass, more preferably 2 to 25 parts by mass, further preferably 2 to 15 parts by mass, further more preferably 2 to 10 parts by mass, based on 100 parts by mass of the total of the thermoplastic resin (A) and the polyphenylene ether (B). When the content of the phosphinates (C) is the lower limit or more, flame retardance can be further enhanced. On the other hand, when the content of the phosphinates (C) is the upper limit or less, the balance among mechanical strength, moldability, and surface appearance of a molded article can be maintained at a higher level.

The unreacted substance, and a by-product in production may remain in the phosphinates (C) as long as the effect of the present embodiment is achieved.

While the phosphinates (C) are used singly as a flame retardant in the present embodiment in terms of the balance between moldability and impact resistance, a flame retardant other than the component (C) may also be contained as long as sufficient flame retardance can be exhibited.

Examples of the flame retardant other than the component (C) may include a combination of flame retardants described in International Publication No. 2005/118698. Such a combination of flame retardants includes an adduct formed from melamine and phosphoric acid, and a zinc-containing compound.

Examples of the adduct formed from melamine and phosphoric acid may include a reaction product of melamine with polyphosphoric acid, a reaction product of a condensate of melamine with polyphosphoric acid, a nitrogen-containing phosphate represented by general formula: (NH₄)_{y}H₃—yPO₄ [wherein y represents an integer of 1 to 3.], a nitrogen-containing phosphate represented by general formula: (NH₄PO₃)ₓ [wherein y represents an integer of 1 to 3 and z represents an integer of 1 to 10000.], ammonium hydrogen phosphate, ammonium dihydrogen phosphate and ammonium polyphosphate. These may be used singly or in combinations of two or more.

In particular, the adduct is represented by general formula: (C₃H₆N₆.HPO₃)ₙ, (wherein n represents the degree of condensation, and represents a numerical number of 3 to 50), and is preferably, for example, a compound obtained from a reaction product of one acid selected from the group consisting of phosphoric acid, pyrophosphoric acid and polyphosphoric acid, with melamine. Melamine and the acid are preferably reacted in substantially equimolar amounts. More specific examples may include dimelamine pyrophosphate, melamine polyphosphate, melem polyphosphate, melam polyphosphate, melon polyphosphate, and one or more selected from these mixed polysalts. Among them, melamine polyphosphate is preferable in terms of general purpose properties.

The method for producing the adduct formed from melamine and phosphoric acid is not particularly limited, and a known method can also be adopted. Specific examples of the method for producing melamine polyphosphate may include a method of heating and condensing melamine phosphate under a nitrogen atmosphere.

Examples of the phosphoric acid forming melamine phosphate may include orthophosphoric acid, phosphorous acid, hypophosphorous acid, metaphosphoric acid, pyrophosphoric acid, triphosphoric acid and tetraphosphoric acid. Usually, melamine polyphosphate obtained by condensation of an adduct of orthophosphoric acid or pyrophosphoric acid with melamine is generally used.

The melamine polyphosphate may include an equimolar addition salt of a linear polyphosphoric acid or a cyclic polymetaphosphoric acid with melamine, so-called a condensed phosphoric acid. The degree n of condensation of the polyphosphoric acid is not particularly limited, but is usually 3 to 50, preferably 5 or more.

Examples of the method for producing a melamine polyphosphate addition salt may include a method including preparing a slurry in which melamine and polyphosphoric acid are dispersed in water, well stirring the slurry to allow the reaction product to be formed into a fine particle, then subjecting this slurry to filtering, washing and drying, and further if necessary firing to provide a solid, and grinding the resulting solid to form a powder. The powder is preferably pre-blended before being compounded in a resin. For example, the powder pre-blended using a high-speed mixer or the like can be used.

The amount of the adduct added, formed from melamine and phosphoric acid, is preferably 20 parts by mass or less, more preferably 10 parts by mass or less, further preferably 5 parts by mass or less, based on 100 parts by mass of the component (C), and further more preferably, the adduct is not substantially contained.

When the adduct formed from melamine and phosphoric acid is added in this range, the effect of slightly enhancing fluidity can be expected, but it is desirable that the adduct formed from melamine and phosphoric acid be not substantially contained from the viewpoint of a further enhancement in surface appearance.

In the adduct formed from melamine and phosphoric acid, an unreacted substance or a by-product in production may remain as long as neither a screw not a mold of a molding machine for use in injection molding is corroded.

Examples of the zinc-containing compound, being other component that can form the combination of flame retardants, may include an inorganic zinc-containing compound. More specifically, examples of the inorganic zinc-containing compound may include zinc oxide, zinc sulfide, zinc borate and zinc stannate. Furthermore, in terms of general purpose properties, zinc borates represented by xZNO.yB₂O₃.zH₂O (wherein x, y and z each independently represent a numerical number greater than 0) are preferable, and zinc borate represented by 2ZnO.3B₂O₃.3.5H₂O, 4ZnO.B₂O₃.H₂O, or 2ZnO.3B₂O₃ is more preferable.

The zinc-containing compound has the function of shielding heat from flame as a heat source to a resin in combustion as a flame retardant aid (shielding ability) to thereby suppress generation of gas serving as a fuel in decomposition of the resin, forming a non-combustible layer (or char layer) required for the enhancement in flame retardant (the effects of the present embodiment, however, are not limited thereto).

Furthermore, as the zinc-containing compound, one can also be used which is treated with a surface treatment agent such as a silane coupling agent or a titanate coupling agent.

The average particle size of the zinc-containing compound is generally 20 μm or less, and is preferably 7 μm or less in terms of mechanical characteristics.

The amount of the zinc-containing compound added is preferably 10 parts by mass or less, more preferably 5 parts by mass or less, further preferably 3 parts by mass or less, based on 100 parts by mass of the total of the phosphinates (C), and further preferably, the zinc-containing compound is not substantially contained. When the content of the zinc-containing compound falls within the above range, the stability of the component (C) at high temperature tends to be further enhanced. In particular, from the viewpoint that while flame retardance is maintained, mechanical characteristics are further enhanced, it is preferable that the zinc-containing compound be not substantially contained.

The method for adding the mixture of the phosphinates (C) with the adduct formed from melamine and phosphoric acid, and the zinc-containing compound to the flame-retardant thermoplastic resin composition of the present embodiment is not particularly limited, and may include a method of separately adding the mixture and the compound singly, and a method including pre-mixing two of the three members or the three members by a high-speed mixer (Henschel mixer) or the like, and then adding them.

### Component (D)

The flame-retardant thermoplastic resin composition of the present embodiment contains (D) at least one colorant (hereinafter, sometimes collectively referred to as “the colorant (D)”) selected from the group consisting of an organic pigment, an inorganic pigment and an organic dye.

As the colorant (D), for example, at least one selected from the group consisting of a known organic pigment, a known organic dye and a known inorganic pigment can be used. A commercial product can also be used as the colorant (D), but, when any of a commercial available organic pigment, a commercial available organic dye and a commercial available inorganic pigment contains iron as an impurity, the kind and the content of the colorant (D) are required to be adjusted so that the content of iron in the flame-retardant thermoplastic resin composition of the present embodiment is less than 50 ppm by addition of the colorant (D).

Examples of the organic pigment and the organic dye may include, but not limited to the following, azo-based pigments such as an azo lake pigment, a benzimidazolone pigment, a diarylide pigment and a condensed azo pigment; phthalocyanine-based pigments such as phthalocyanine blue and phthalocyanine green; condensed polycyclic pigments such as an isoindolinone pigment, a quinophthalone pigment, a quinacridone pigment, a perylene pigment, an anthraquinone pigment, a perinone pigment and dioxadine violet; and an azine-based dye and carbon black.

Carbon black preferably has an amount of dibutyl phthalate (DBP) absorbed of less than 250 mL/100 g, more preferably less than 150 mL/100 g. Then, carbon black preferably has a nitrogen adsorption specific surface area of less than 900 m²/g, more preferably less than 400 m²/g. Furthermore, carbon black particularly preferably has an amount of DBP absorbed in the above range and has a nitrogen adsorption specific surface area in the above range. When the amount of DBP absorbed and the nitrogen adsorption specific surface area fall within the above ranges, respectively, colouring ability, mechanical strength, and flame retardance are further enhanced. Herein, the amount of DBP absorbed can be measured by the method according to ASTM D2414. The nitrogen adsorption specific surface area can be measured by the method according to JIS K6217.

Examples of the azine-based dye may include Solvent Black 5 (C.I.50415, CAS No. 11099-03-9), Solvent Black 7 (C.I.50415:1, CAS No. 8005-20-5/101357-15-7) and Acid Black 2 (C.I.50420, CAS No. 8005-03-6/68510-98-5) in the Color Index.

Examples of the inorganic pigment may include metal oxides excluding iron oxide, such as titanium oxide, zinc oxide and chromium oxide, and composite metal oxides such as titan yellow, cobalt blue and ultramarine blue.

For example, when carbon black is added also for the purpose of imparting conductivity, iron may be contained in carbon black in a relatively high concentration. In such a case, the content of carbon black is adjusted so that the content of iron in the flame-retardant thermoplastic resin composition of the present embodiment is less than 50 ppm. From such a viewpoint, for example, the content of carbon black in the flame-retardant thermoplastic resin composition of the present embodiment is preferably 0.01 to 2% by mass, more preferably 0.01 to 1.5% by mass, further preferably 0.01 to 1.0% by mass.

### Content of Iron Element

The content of an iron element in the flame-retardant thermoplastic resin composition of the present embodiment is less than 50 ppm, preferably less than 30 ppm, more preferably 25 ppm or less, on a mass basis. This content of an iron element means the content of an iron compound in terms of mass, and is on an iron element basis. In addition, the content of an iron element is preferably 1 ppm or more in terms of productivity and economic efficiency. When the content of an iron element in the flame-retardant thermoplastic resin composition is 50 ppm or more, a flame-retardant thermoplastic resin composition excellent in flame retardance and surface appearance of a molded article cannot be obtained.

Example of the method for measuring the content of an iron element may include a method including precisely weighing 0.25 g of the flame-retardant thermoplastic resin composition subjected to a drying treatment in advance in a fluororesin vessel in a clean room, adding thereto sulfuric acid and nitric acid, subjecting the resultant to pressure acid decomposition by a microwave decomposition apparatus to provide a decomposition liquid, weighing 25 mL of this decomposition liquid to provide a measurement solution, and subjecting the measurement solution to measurement by the absolute calibration method using an ICP mass spectrometer (internal standard: cobalt). More specifically, the content can be measured by a method described in Example described later. Herein, the measurement of the content of an iron element is preferably performed using a hydrogen gas for a reaction gas because it faces the interference due to an argon gas being a plasma gas.

While selection of the colorant (D) is one that may be considered for decreasing the content of an iron element in the flame-retardant thermoplastic resin composition of the present embodiment to less than 50 ppm, the increase in content of an iron element is also caused by any factor other than the colorant (D), and, in light of this, the content of an iron element in the flame-retardant thermoplastic resin composition of the present embodiment may be thus less than 50 ppm (the effects of the present embodiment, however, are not limited thereto).

Examples of the method for reducing the content of an iron element may include a method of allowing pellet(s) of the raw materials and/or the flame-retardant thermoplastic resin composition to pass through a magnetic force separator equipped with a magnetic force generation source, to remove a component containing a magnetic body in a predetermined amount or more; a method of using deionized water as water for cooling a strand taken out from an extruder after melt-kneading; a method of shortening a time for immersing a strand in cooling water to the extent possible; and a method of selecting the raw materials other than the colorant (D) and additive(s) containing an iron element in a small amount. These methods may be used singly or in combinations of two or more.

### Component (E)

When the component (A) is at least one selected from the polyolefin-based resin, the polyester-based resin, the polyamide-based resin, the polyarylene sulfide, the polyetherimide, the polyethersulfone, the polysulfone, the polyarylketone and mixtures thereof, the flame-retardant thermoplastic resin composition of the present embodiment preferably contains further (E) a compatibilizing agent of the component (A) and the component (B).

The compatibilizing agent (E) is not particularly limited, but examples thereof may include an inorganic metal oxide, a functional group-containing organic compound, and a copolymer having polystyrene chain-polyolefin chain. The compatibilizing agent (E) can be appropriately suitably selected depending on the kind and content of the thermoplastic resin (A) used in combination with the polyphenylene ether (B).

Examples of the inorganic metal oxide may include an oxide of at least one metal selected from the group consisting of zinc, titanium, calcium, magnesium and silicon. Among them, zinc oxide is preferable in terms of a compatibilizing force. Examples of the functional group-containing organic compound may include an organic compound having one or more functional groups selected from the group consisting of an epoxy group, an oxazolyl group, an imide group, a carboxylic group and an acid anhydride group. The number of functional groups contained in one molecule is 1, or 2 or more. When two or more functional groups are contained, the kind of the functional groups may be single or two or more. Examples of the copolymer having polystyrene chain-polyolefin chain may include a styrene-ethylene-butylene copolymer.

### Case Where Thermoplastic Resin (A) is Polyolefin-Based Resin

Described is a preferable compatibilizing agent (E) in a combination of the polyphenylene ether (B) and the polyolefin-based resin (A), particularly PP. Since polyphenylene ether is essentially immiscible with PP, a compatibility agent is preferably used. A polymer alloy of polyphenylene ether and PP represents a structure in which polyphenylene ether is dispersed in a PP continuous phase, and polyphenylene ether plays an important role in terms of strengthening heat resistance at a temperature equal to or higher than the glass transition temperature of an amorphous part of PP. For the purpose of the improvement in miscibility between them, a copolymer having a segment chain highly miscible with polyphenylene ether and a segment chain highly miscible with PP can be utilized as an admixture. Examples of such a copolymer having miscibility may include a copolymer having a polystyrene chain-polyolefin chain, a copolymer having a polyphenylene ether chain-polyolefin chain, and a hydrogenated block copolymer obtained by hydrogenating a block copolymer including at least two polymer blocks A mainly having a vinyl aromatic compound and at least one polymer block B mainly having a conjugate diene compound. Among them, a hydrogenated block copolymer is preferable in terms of heat stability.

Examples of the hydrogenated block copolymer as the compatibilizing agent (E) of polyphenylene ether and PP here may include a hydrogenated block copolymer obtained by hydrogenating a block copolymer having a structure such as A-B-A, A-B-A-B, (A-B-)₄—Si or A-B-A-B-A. Herein, A means a polymer block mainly having a vinyl aromatic compound, and B means a polymer block mainly having a conjugate diene compound. Each of the content of the vinyl aromatic compound in the polymer block A and the content of the conjugate diene compound in the polymer block B is at least 70% by mass or more. Furthermore, the hydrogenated block copolymer means a block copolymer including an aromatic vinyl compound-conjugate diene compound, in which the rate of an olefinic unsaturated bond derived from the conjugate diene compound is preferably reduced by a hydrogenating reaction to 50% or less, more preferably 30% or less, further preferably 10% or less.

Among the block copolymers, a block copolymer that can be more suitably used as the compatibilizing agent (E) of polyphenylene ether and PP may include a so-called high vinyl-based block copolymer in which the rate of a 1,2-vinyl bond in a polybutadiene moiety as the conjugate diene compound is 50 to 90%.

### Case Where Thermoplastic Resin (A) is Polyamide-Based Resin

A compatibilizing agent (E) in a combination of the polyphenylene ether with the polyamide-based resin is not limited to the following, but, for example, those described in Japanese Patent Laid-Open No. 08-048869 and Japanese Patent Laid-Open No. 09-124926 can be used. The compatibilizing agent (E) may be used singly or in combinations of two or more. When the compatibilizing agent (E) is used in the combination of the polyphenylene ether with the polyamide-based resin, a compatibilizing agent belonging to any of the following first to third groups is preferable.

A compatibilizing agent in the first group may include one having in its molecule, (a) a carbon-carbon double bond or a carbon-carbon triple bond, and (b) at least one functional group selected from the group consisting of a carboxylic group, an acid anhydride group, an acid halide group, an anhydride group, an acid halide anhydride group, and acid amide group, and acid ester group, an imide group, an amino group and a hydroxyl group.

Examples of such a compatibilizing agent that is a so-called polyfunctional compound may include, but not limited to the following, maleic acid, maleic anhydride, fumaric acid, citraconic acid, itaconic acid, maleimide and maleic hydrazide; a reaction product resulting from diamine with maleic anhydride, maleic acid, fumaric acid or the like; dichloromaleic anhydride, maleic acid amide and unsaturated dicarboxylic acids (examples may include acrylic acid, butenoic acid, methacrylic acid, t-ethylacrylic acid, pentenoic acid, decenoic acid, undecenoic acid, dodecenoic acid and linoleic acid); esters, acid amides or anhydrides of the above unsaturated carboxylic acids; unsaturated alcohols (examples may include alkyl alcohol, crotyl alcohol, methylvinyl carbinol, 4-penten-1-ol, 1,5-hexadien-3-ol, 3-butene-1,4-diol and 2,5-dimethyl-3hexene-2,5-diol); an unsaturated amine in which OH-group(s) of any unsaturated alcohol selected from an alcohol represented by the following general formula (i), an alcohol represented by the following general formula (ii) and an alcohol represented by the following general formula (iii) are substituted with —NH₂ group(s); and functionalized diene polymer and copolymer.

CₙH₍₂ₙ₋₁₎OH (i)

wherein n represents an integer of 3 to 30.

CₙH_{(2n·b)}OH (ii)

wherein n represents an integer of 4 to 30.

CₙH_{2n-y)}OH (iii)

wherein n represents an integer of 5 to 30.

Among these compatibilizing agents in the first group, a preferable compatibilizing agent as the compatibilizing agent (E) for use in the flame-retardant thermoplastic resin composition of the present embodiment may include maleic anhydride. The above compatibilizing agents in the first group can be each reacted with the polyphenylene ether (B) for use in the flame-retardant thermoplastic resin composition of the present embodiment, in advance.

A compatibilizing agent in the second group may include a compatibilizing agent having (a): a group represented by general formula (OR) (wherein R represents hydrogen, or an alkyl group, an aryl group, an acyl group or a carbonyloxy group), and (b): at least two groups selected from the group consisting of carboxylic acid, acid halide, acid anhydride, anhydride, acid halide anhydride, acid ester, acid amide, imide, amino and salts thereof. The groups (b) may be the same or different.

Examples of the compatibilizing agent in the second group may include, but not limited to the following, aliphatic polycarboxylic acid, acid ester and acid amide each represented by the following general formula (iv).

(R_{I}O)ₙR(COOR_{IX})ₙ(CONR_{III}R_{IV})ₛ (iv)

wherein R represents a linear or branched saturated aliphatic hydrocarbon group having 2 to 20 carbon atoms, preferably 2 to 10 carbon atoms, R_{I} represents a hydrogen atom, an alkyl group having 1 to 10 carbon atoms, preferably 1 to 6 carbon atoms, more preferably 1 to 4 carbon atoms, an aryl group, an acyl group or a carbonyldioxy group, each R_{II} independently represents a hydrogen atom, an alkyl group having 1 to 20 carbon atoms, preferably 1 to 10 carbon atoms, or an aryl group, R_{III} and R_{IV} each independently represent a hydrogen atom, an alkyl group having 1 to 10 carbon atoms, preferably 1 to 6 carbon atoms, more preferably 1 to 4 carbon atoms, or an aryl group, m represents 1, (n+s) equals to 2 or more, preferably 2 or 3, and n and s each independently represent 0 or more.

Herein, (R_{I}O) in general formula (iv) is located at the α- or β-position relative to a carbonyl group, and thus at least two carbonyl groups are spaced by 2 to 6 carbon atoms.

Example of the aliphatic polycarboxylic acid as the above compatibilizing agent in the second group may include citric acid, malic acid and agaricic acid, and such acids may be in various modes such as an anhydride and an acid hydrate. Among them, citric acid is preferable. Examples of the acid ester may include acetyl citrate, monostearyl citrate and distearyl citrate. Examples of the acid amide may include N,N′-diethylcitric acid amide, N-phenylcitric acid amide, N-dodecylcitric acid amide, N,N′-didodecylcitric acid amide and N-dodecylmalic acid.

The above compatibilizing agents belonging to the second group may be not only the above various compounds but also derivatives thereof. Examples of such derivatives may include salts of the above various compounds (examples may include salts with an amine, alkali metal salts and alkali earth metal salts). Specifically, examples may include calcium malate, calcium citrate, potassium malate and potassium citrate.

A compatibilizing agent in the third group may include a compatibilizing agent having in its molecule, (a): an acid halide group, preferably an acid chloride group, and (b): a carboxylic group, a carboxylic anhydride group and an acid ester group or an acid amide group, preferably at least one of a carboxylic group or a carboxylic anhydride group. Examples of the compatibilizing agent in the third group may include trimellitic anhydride acid chloride, chloroformyl succinic anhydride, chloroformyl succinic acid, chloroformyl glutaric anhydride, chloroformyl glutaric acid, chloroacetyl succinic anhydride, chloroacetyl succinic acid, trimellitic acid chloride and chloroacetyl glutaric acid. Among them, trimellitic anhydride acid chloride is preferable. Furthermore, the compatibilizing agent in the third group is preferably used in the form of a PPE-functionalized compound of the compatibilizing agent by a reaction with at least one part of the polyphenylene ether (B) in advance.

Among these various compatibilizing agents (C), in particular, one or more selected from citric acid, maleic acid, itaconic acid and anhydrides thereof are more preferable. In particular, maleic anhydride and citric acid are further preferable.

The content of the compatibilizing agent (E) is preferably 0.01 to 20 parts by mass, more preferably 0.1 to 10 parts by mass, further preferably 0.1 to 5 parts by mass, based on 100 parts by mass of the total of the polyamide-based resin and the polyphenylene ether.

### Case Where Thermoplastic Resin (A) is PPS

A preferable compatibilizing agent in a combination of the polyphenylene ether (B) with (A) PPS is described. A polymer alloy of polyphenylene ether and PP preferably has a structure in which the polyphenylene ether is dispersed in a PPS matrix. The glass transition temperature of the polyphenylene ether is high, thereby making it possible to enhance heat resistance to a temperature equal to or higher than the glass transition temperature of an amorphous part of PPS. Since the polyphenylene ether is essentially immiscible with PP, a copolymer containing a compound containing an epoxy group and/or oxazolyl group is preferable. Such a compatibilizing agent can be used to thereby remarkably reduce the occurrence of burr of a molded article in subjecting the flame-retardant thermoplastic resin composition of the present embodiment to pellet molding.

Among them, a copolymer obtained by at least copolymerizing an unsaturated monomer having an epoxy group and/or oxazolyl group with a styrene monomer is preferable. In this copolymer, not only the unsaturated monomer having an epoxy and/or oxazolyl group and the styrene monomer, but also other monomer may also be copolymerized.

Examples of other monomer may include an unsaturated monomer containing any substituent selected from the group consisting of an amino group, a hydroxyl group, a carboxyl group, a mercapto group, an isocyanate group, an acid anhydride group and an ester group. These may be used singly or in combinations of two or more.

The proportion of the unsaturated monomer having an epoxy group and/or oxazolyl group in the total amount of the monomer is preferably 0.3% by mass or more, more preferably 1 to 15% by mass, in the total amount. The proportion of the styrene monomer in the total amount of the monomer is preferably 50% by mass or more, more preferably 65% by mass or more. The proportion of other monomer in the total amount of the monomer is preferably 49.7% by mass or less, more preferably 49.0% by mass or less.

Preferable specific examples of the copolymer may include (i) a copolymer of an unsaturated monomer having an epoxy group and/or oxazolyl group with a styrene monomer (epoxy group and/or oxazolyl group-containing polystyrene-based copolymer), and (ii) a copolymer of an unsaturated monomer having an epoxy group and/or oxazolyl group with styrene and acrylonitrile monomers. With respect to the proportion of each monomer in the copolymer (ii), preferably, the total proportion of the unsaturated monomer having an epoxy group and/or oxazolyl group and the styrene monomer is 90 to 75% by mass, and the proportion of the acrylonitrile monomer is 10 to 25% by mass.

Examples of the unsaturated monomer having an epoxy group may include glycidyl methacrylate, glycidyl acrylate, vinyl glycidyl ether, glycidyl ether of hydroxyalkyl (meth)acrylate, glycidyl ether of polyalkylene glycol (meth)acrylate, and glycidyl itaconate. Among the, glycidyl methacrylate is preferable. As a vinyl oxazoline compound being the unsaturated monomer having an oxazolyl group, for example, 2-isopropenyl-2-oxazoline is preferable in terms of availability.

Other unsaturated monomer copolymerized with the unsaturated monomer having an epoxy group and/or oxazolyl group may include, in addition to vinyl aromatic compounds such as styrene, vinyl cyanide monomers such as acrylonitrile, and vinyl acetate and (meth)acrylates as copolymerizing components, but at least 65% by mass or more of the styrene monomer is preferably contained in a compound excluding the unsaturated monomer having an epoxy group and/or oxazolyl group, from the viewpoint of more effectively acting as the compatibilizing agent of PPS and polyphenylene ether.

The content of the unsaturated monomer having an epoxy group and/or oxazolyl group in the copolymer is preferably 0.3 to 20% by mass, more preferably 1 to 15% by mass, further preferably 3 to 10% by mass. When the content of the unsaturated monomer falls within the above range, miscibility of polyphenylene ether and PPS can be further enhanced, the occurrence of burr in a molded article of the flame-retardant thermoplastic resin composition can be further effectively suppressed, and furthermore the balance among heat resistance, toughness (impact strength) and mechanical strength can be maintained at a higher level.

Specific examples of such a copolymer may include a styrene-glycidyl methacrylate copolymer, a styrene-glycidyl methacrylate-methyl methacrylate copolymer, a styrene-glycidyl methacrylate-acrylonitrile copolymer, a styrene-vinyl oxazoline copolymer and a styrene-vinyl oxazoline-acrylonitrile copolymer.

The content of the compatibilizing agent (E) is preferably 0.5 to 5 parts by mass, more preferably 1 to 5 parts by mass, further preferably 1 to 3 parts by mass, based on 100 parts by mass of the total of polyphenylene ether and PPS. When the content of the compatibilizing agent (E) is the lower limit or more, miscibility of PPS and polyphenylene ether can be further enhanced. When the content of the compatibilizing agent (E) is the upper limit or less, the average particle size of the polyphenylene ether forming a dispersion phase is easily controlled to 10 μm or less, surface appearance of a molded article can be further enhanced, and the occurrence of burr can be more effectively suppressed. Furthermore, the balance among heat resistance, impact strength, toughness and mechanical strength can be maintained at a higher level.

Herein, a polyphenylene ether particle is preferably present in a PPS continuous phase as a dispersion phase where the average particle size is 10 μm or less. The average particle size is more preferably 8 μm or less, further preferably 5 μm or less. When the average particle size is the upper limit or less, surface appearance can be further enhanced, and a peeling phenomenon on the surface of a molded article can be more effectively prevented. An impact resistant agent such as (F) a component described later is preferably present in a polyphenylene ether dispersion phase.

### Case Where Thermoplastic Resin (A) is Polyester-Based Resin

Described is a preferable compatibilizing agent (E) in a combination of the polyphenylene ether (B) and the polyolefin-based resin (A). Such a compatibilizing agent (E) is preferably a compound having an epoxy group, an oxazolyl group, an imide group, a carboxylic group or an acid anhydride group. Among them, a compound having an epoxy group is more preferable. Specific examples of such a compatibilizing agent (E) may include a glycidyl methacrylate/styrene copolymer, a glycidyl methacrylate/styrene/methyl methacrylate copolymer, a glycidyl methacrylate/styrene/methyl methacrylate/methacrylate copolymer, a glycidyl methacrylate/styrene/acrylonitrile copolymer, a vinyl oxazoline/styrene copolymer, an N-phenylmaleimide/styrene copolymer, an N-phenylmaleimide/styrene/maleic anhydride copolymer and a styrene/maleic anhydride copolymer. In addition, a graft copolymer such as a graft copolymer of an ethylene/glycidyl methacrylate copolymer and polystyrene may be adopted. Among them, a glycidyl methacrylate/styrene copolymer, a vinyl oxazoline/styrene copolymer, an N-phenylmaleimide/styrene copolymer, and an N-phenylmaleimide/styrene/maleic anhydride copolymer are preferable, and a glycidyl methacrylate/styrene copolymer is more preferable.

The ratio of a compound having at least one functional group selected from the group consisting of an epoxy group, and oxazolyl group, an imide group, a carboxylic group and an acid anhydride group to a styrene-based compound in the copolymer is not particularly limited, but the proportion of the compound having an epoxy group, an oxazolyl group, and imide group, a carboxylic group or an acid anhydride group is preferably 50% by mass or less based on 100% by mass of the total of the compound and the styrene-based compound from the viewpoints of suppression of silver streaks in molding and suppression of buildup in processing.

The content of the compatibilizing agent (E) is preferably 0.1 parts by mass or more and 10 parts by mass or less, more preferably 1 part by mass or more and 7 parts by mass or less, further preferably 3.5 parts by mass or more and 6 parts by mass or less, based on 100 parts by mass of the total of the polyphenylene ether and the polyester-based resin. When the content of the compatibilizing agent is the lower limit or more, tensile strength can be further enhanced. When the content of the compatibilizing agent is the upper limit or less, flame retardance can be further enhanced.

The method for adding the compatibilizing agent (E) is not particularly limited, but, for example, preferable is a method of adding it together with the polyphenylene ether, or a method of producing a masterbatch melt-kneaded with the polyester-based resin in advance and then adding it together with polyphenylene ether. Herein, it is preferable that the polyphenylene ether form a dispersion phase and the polyester-based resin form a continuous phase. When the polyester-based resin forms a continuous phase, chemical resistance and rigidity are excellent. Such a dispersing mode can be determined by observing the cross-section or the like of a molded article using a transmission microscope, for example.

The dispersed particle size of the polyphenylene ether is preferably 40 μm or less, more preferably 20 μm or less. This dispersed particle size can be measured by observation with a transmission electron microscope at a magnification of 10000, and image analysis. When an impact resistant agent such as (F) a component described later is compounded, the impact resistant agent is preferably present in a polyphenylene ether dispersion phase. It is also useful to form a sea-island-lake structure in which the polyester-based resin is further present in a polyphenylene ether phase as the dispersion phase.

One example of a specific method for forming the sea-island-lake structure may include a method including supplying the polyphenylene ether, a part of polyester, and if necessary, a compatibilizing agent of them by using an extruder having one or more supply ports on the middle thereof, from a supply port of the extruder, and supplying the remaining polyester-based resin from a supply port on the middle of the extruder.

### Case Where Thermoplastic Resin (A) is Resin Other Than Polyolefin-Based Resin, Polyamide-Based Resin, PPS and Polyester-Based Resin

As a compatibilizing agent (E) in the case of using a resin other than the polyolefin-based resin, the polyamide-based resin, PPS and the polyester-based resin in combination with the polyphenylene ether in the present embodiment, for example, the above-mentioned compatibilizing agent of the thermoplastic resin such as polypropylene, the polyamide-based resin, PPS or the polyester-based resin, and the polyphenylene ether can also be used. Since the resin such as polyarylate, polyetherimide, polyethersulfone, polysufone or polyarylketone described here is generally required for a high processing temperature, the terminal functional group thereof is often inactivated by reaction, and it is thus preferable that, after any reaction (for example, cleavage reaction of a molecular chain by heat, peroxide, or the like) is allowed to occur, the above compatibilizing agent be appropriately selected and used.

In the present embodiment, compatibilizing can be performed without the above reaction occurring. Such a method may include a method of adding polyarylate as a compatibilizing agent of the polyphenylene ether and polyarylketone in a small amount.

### Component (F))

The flame-retardant thermoplastic resin composition of the present embodiment preferably contains further (F) an impact resistant agent. Examples of the component (F) may include a block copolymer including at least one block mainly having an aromatic vinyl compound and at least one block mainly having a conjugate diene compound, and/or a hydrogenated product of the block copolymer, and a polyolefin-based elastomer. Among them, when the component (A) is the polyamide-based resin or the polystyrene-based resin, a block copolymer including at least one block mainly having an aromatic vinyl compound and at least one block mainly having a conjugate diene compound, and/or a hydrogenated product of the block copolymer.

Herein, the “mainly having an aromatic vinyl compound” means that at least 50% by mass or more of the monomer forming the block corresponds to an aromatic vinyl monomer unit, and the aromatic vinyl monomer unit preferably accounts for 70% by mass or more, more preferably 80% by mass or more, further preferably 90% by mass or more. The “mainly having a conjugate diene compound” means that at least 50% by mass or more of the monomer forming the block corresponds to a conjugated diene monomer unit, and the conjugated diene monomer unit preferably accounts for 70% by mass or more, more preferably 80% by mass or more, further preferably 90% by mass or more.

Examples of the block mainly having an aromatic vinyl compound may include a copolymer block obtained by bonding a small amount of a conjugate diene compound into an aromatic vinyl polymer block at random. Examples of the block mainly having a conjugate diene compound may include a copolymer block obtained by bonding a small amount of an aromatic vinyl compound into a conjugated diene polymer block at random.

The aromatic vinyl compound forming the block copolymer as the component (F) is not particularly limited, but examples thereof may include styrene, α-methylstyrene and vinyl toluene. These may be used singly or in combinations of two or more. Among them, styrene is preferable in terms of impact resistance.

The conjugate diene compound forming the block copolymer is not particularly limited, but examples thereof may include butadiene, isoprene and piperylene(1,3-pentadiene). These may be used singly or in combinations of two or more. Among them, butadiene, isoprene and combinations thereof are preferable in terms of impact resistance.

When the component (F) is a block copolymer including at least one block mainly having an aromatic vinyl compound and at least one block mainly having a conjugate diene compound, and/or a hydrogenated product of the block, a hydrogenated styrene-ethylene-butylene copolymer, a hydrogenated styrene-isobutylene-styrene copolymer or the like is preferable.

When the component (F) is a polyolefin-based elastomer, a low crystalline or amorphous olefin-based copolymer, having a crystallinity measured by the X-ray diffraction method of 50% or less, is preferable. Examples of the olefin forming the polyolefin-based elastomer may include α-olefins such as ethylene, propylene, 1-butene, isobutylene, 1-pentene, 1-hexene, 4-methyl-1-pentene, 3-methyl-1-butene, 2-methyl-1-butene, 1-hexane, 1-oxtene, 1-decene and 1-dodecene, and cyclic olefins such as cyclobutene, cyclopentene and cyclohexene. Among them, ethylene, propylene, 1-hexene, 1-butene and 1-octene are preferable. These may be used singly or in combinations of two or more. Among such polyolefin-based elastomers, and ethylene-α-olefin copolymer rubber is preferable, and an ethylene/propylene copolymer, an ethylene/1-octene copolymer, a propylene/1-butene/ethylene copolymer and a propylene/1-hexene/ethylene copolymer are more preferable in terms of impact resistance.

When the component (A) is polyphenylene sulfide and/or polybutylene terephthalate, the component (F) is preferably a polyolefin-based elastomer.

When the component (A) is the polypropylene-based resin, the component (F) is preferably a polyolefin-based elastomer, more preferably an ethylene-α-olefin copolymer.

When the component (F) is a hydrogenated block copolymer (hydrogenated product of block copolymer) such as a hydrogenated styrene-ethylene-butylene copolymer or a hydrogenated styrene-isobutylene-styrene copolymer, the content of 1,2-vinyl, or the total of the content of 1,2-vinyl and the content of 3,4-vinyl (the total amount in a 1,2-bonding structure and a 3,4-bonding structure of a conjugate diene compound) in a microstructure of a conjugated diene polymer block moiety of the hydrogenated block copolymer is preferably 5% or more and less than 50%, more preferably 10% or more and less than 50%, further preferably 15% or more and less than 40%, based on the amount of the total bonds (the total amount in a 1,2-bonding structure, a 3,4-bonding structure and a 1,4-bonding structure of a conjugate diene compound).

The block copolymer before hydrogenation is preferably a block copolymer having an aromatic vinyl polymer block (a) and a conjugated diene polymer block (b) in any bonding type selected from the group consisting of a-b type, a-b-a type and a-b-a-b type. Such bonding types may be adopted singly or in combinations of two or more. Among them, a-b-a type and a-b-a-b type are preferable, and a-b-a type is further preferable.

The block copolymer as the component (F) is preferably a partially hydrogenated block copolymer (partially hydrogenated block copolymer) from the viewpoint of suppressing the deterioration in impact resistance of the flame-retardant thermoplastic resin composition of the present embodiment under a high-temperature environment.

The partially hydrogenated block copolymer refers to a copolymer that is controlled in terms of hydrogenation by hydrogenating the above unhydrogenated block copolymer so that, with respect to the proportion of an aliphatic double bond in the conjugated diene polymer block (amount of aliphatic double bond after hydrogenation/amount of aliphatic double bond before hydrogenation), the amount of an aliphatic double bond before hydrogenation falls within more than 0% and less than 100%. The rate of hydrogenation of the partially hydrogenated block copolymer is preferably 50% or more and less than 100%, more preferably 80% or more and less than 100%, further preferably 98% or more and less than 100%. When the rate of hydrogenation falls within the above range, the flame-retardant thermoplastic resin composition of the present embodiment can achieve excellent physical properties so as to be more suitably utilized for electric and electronic components such as a connector, a breaker and a magnetic switch, electric components in the automobile field, typified by a relay block, and materials for components in airplanes.

When the component (F) is a block copolymer including at least one block mainly having an aromatic vinyl compound and at least one block mainly having a conjugate diene compound, and/or a hydrogenated product of the block copolymer, the number average molecular weight of the component (F) is preferably 150000 or more, more preferably 150000 or more and less than 300000, further preferably 170000 to 300000, further more preferably 170000 to 280000. When the number average molecular weight of the block copolymer falls within the above range, a flame-retardant thermoplastic resin composition superior in fluidity, impact strength and flame retardance can be obtained.

The evaluation method of the number average molecular weight of the block copolymer as the component (F) in the flame-retardant thermoplastic resin composition of the present embodiment is shown below.

A solvent is selected which is high in solubility to the thermoplastic resin (A) and low in solubility to the polyphenylene ether (B) and the component (F). This solvent is used to fractionate a mixture of the polyphenylene ether (B) and the component (F) as an insoluble from the flame-retardant thermoplastic resin composition.

Then, a solvent is selected which exhibits a high solubility to the component (F) and exhibits a low solubility to the polyphenylene ether (B) (for example, chloroform). Then, this solvent is used to fractionate the component (F) from the above insoluble.

Then, the component (F) fractionated can be subjected to analysis using a gel permeation chromatography measurement apparatus (“GPC SYSTEM21” manufactured by Showa Denko K. K.) and an ultraviolet spectrometric detector (“UV-41” manufactured by Showa Denko K. K.) to determine the number average molecular weight of the block copolymer in the component (F). More specifically, the number average molecular weight can be measured according to a method described in Examples.

While a low molecular weight component generated by inactivation of a catalyst in a polymerization reaction may be detected during the measurement, such a low molecular weight component in this case is not included in molecular weight calculation (not considered). In the present embodiment, such a mode can be adopted to thereby control the molecular weight distribution (weight average molecular weight/number average molecular weight) at a high level. For example, the polymerization conditions and the like can be controlled to thereby sufficiently control the molecular weight distribution within the range from 1.0 to 1.1.

Such a block copolymer may be used as a mixture of two or more copolymers of each of different bonding types, different aromatic vinyl compounds, different conjugate diene compounds, different contents of 1,2-bond vinyl or different contents of 1,2-bond vinyl and different contents of 3,4-bond vinyl, different aromatic vinyl compound component contents, and different rates of hydrogenation. That is, the block copolymer may be used singly or in combinations of two or more.

When the component (F) is a block copolymer including at least one block mainly having an aromatic vinyl compound and at least one block mainly having a conjugate diene compound, and/or a hydrogenated product of the block copolymer, the component (F) may be a block copolymer fully or partially modified with a modifying group (hereinafter, sometimes referred to as “modified block copolymer”). The modified block copolymer as used herein refers to a block copolymer modified with a modifying compound having in its molecular structure, at least one carbon-carbon double bond or triple bond, and at least one selected from the group consisting of a carboxylic group, an acid anhydride group, an amino group, a hydroxyl group and a glycidyl group. The modifying compound may be used singly or in combinations of two or more.

Examples of the method for producing the modified block copolymer may include, but not limited to the following, in the presence or absence of a radical initiator, (1) a method of melt-kneading and reacting the block copolymer and the modifying compound within the temperature range of the softening point temperature of the block copolymer, or higher, and 250° C. or lower, (2) a method of reacting the block copolymer and the modifying compound in a solution at a temperature of the softening point of the block copolymer, or lower, and (3) a method of reacting the block copolymer and the modifying compound at a temperature of the softening point of the block copolymer, or lower, without melting them. Any of these methods can be adopted, but the method (1) is preferable, and the method (1), in which the reaction is performed in the presence of a radical initiator, is more preferable.

The content of the component (F) in the flame-retardant thermoplastic resin composition of the present embodiment is preferably 3 to 20 parts by mass, more preferably 5 to 15 parts by mass, further preferably 5 to 12 parts by mass, based on 100 parts by mass of the total amount of the thermoplastic resin (A) and the polyphenylene ether (B).

Herein, one example of a more preferable combination of the above respective components may include the following combinations. Such combinations can be selected to thereby achieve a superior effect:

a case where the component (A) is a polyamide-based resin, the component (E) is maleic anhydride and/or maleic acid, and the component (F) is a hydrogenated styrene-ethylene-butylene copolymer (SEBS) and/or a hydrogenated styrene-isobutylene-styrene copolymer (SEIS);

a case where the component (A) is a polystyrene-based resin and the component (F) is a hydrogenated styrene-ethylene-butylene copolymer;

a case where the component (A) is a polypropylene-based resin, the component (E) is a hydrogenated styrene-ethylene-butylene copolymer (SEBS), and the component (F) is an ethylene-α-olefin copolymer rubber; and

a case where the component (A) is polyphenylene sulfide and/or polybutylene terephthalate, the component (E) is an epoxy group and/or oxazolyl group-containing polystyrene-based polymer, and the component (F) is a polyolefin-based elastomer.

The above combination can be adopted to thereby allow the balance among molding fluidity, mechanical characteristics and flame retardance to be more suitable, and thus is particularly suitable when the flame-retardant thermoplastic resin composition of the present embodiment is used as a material of a relay block or the like.

(Other Materials)

The flame-retardant thermoplastic resin composition of the present embodiment may further contain other components (examples may include an inorganic filler and various additives other than the above) if necessary.

Examples of the inorganic filler may include fiber-like, particle-like, plate-like or needle-like inorganic reinforcing materials such as a glass fiber, a potassium titanate fiber, a plaster fiber, a brass fiber, a ceramics fiber, a boron whisker fiber, mica, talc, silica, calcium carbonate, kaolin, fired kaolin, wollastonite, xonotlite, apatite, glass beads, flake-like glass and titanium oxide. These may be used singly or in combinations of two or more. Among them, a glass fiber, a carbon fiber and glass beads are preferable. In addition, the inorganic filler may be surface-treated with a surface treatment agent such as a silane coupling agent. A natural ore-based filler, however, may often contain an iron element in a slightly small amount, and thus one from which an iron element is removed by purification is preferably selected and used.

Example of the additive may include other thermoplastic resins such as polyester and polyolefin, plasticizers (a low molecular weight olefin, polyethylene glycol, fatty acid ester, and the like), an antistatic agent, a nucleating agent, a fluidity improver, a reinforcing agent, various peroxides, a spreading agent, a copper-based heat stabilizer, an organic heat stabilizer typified by a hindered phenolic oxidative degradation inhibitor, an antioxidant, an ultraviolet absorber, and a light stabilizer.

Each of the contents of other components described above in the flame-retardant thermoplastic resin composition of the present embodiment is preferably 10% by mass or less, more preferably less than 5% by mass, further preferably 3% by mass or less.

### Method for Producing Flame-Retardant Thermoplastic Resin Composition

The flame-retardant thermoplastic resin composition of the present embodiment can be produced using the respective components including the components (A) to (D) described above by a conventionally known melt-kneading method or the like.

Examples of the melt-kneading method may include methods of melt-kneading using a single screw extruder, a twin screw extruder, a roll, kneader, Brabender Plastograph, a bunbury mixer, and the like. Among them, a melt-kneading method is preferable in which a twin screw extruder is used, and a melt-kneading method is more preferable in which a twin screw extruder provided with a supply port at an upstream side and one or more supply ports at a downstream side is used. The melt-kneading temperature is usually preferably 280 to 340° C.

### Molded Article and Method for Producing the Same

A molded article can be produced by using the flame-retardant thermoplastic resin composition of the present embodiment, and subjecting it to molding by a conventionally known molding method such as injection molding, extrusion, press molding, blow molding, calendering and film casting. That is, a molded article of the present embodiment may include the flame-retardant thermoplastic resin composition. The molding method is not particularly limited, and a known method can also be adopted. For example, the flame-retardant thermoplastic resin composition can be molten in the cylinder of an injection molding machine, and injected into a mold having a predetermined shape to thereby produce a molded article having a predetermined shape. The flame-retardant thermoplastic resin composition can also be molten in an extruder in which the cyclinder temperature is controlled, and spun out from a tube nozzle to thereby produce a fiber-like molded article. The flame-retardant thermoplastic resin composition can also be molten in an extruder in which the cyclinder temperature is controlled, and extruded from a T die to thereby produce a film-like or sheet-like molded article. Furthermore, the molded article produced by such a method may also have a covering layer made of a paint, a metal, other polymer or the like formed on the surface thereof. That is, a laminate can also be formed which is provided with the molded article of the present embodiment, and the covering layer formed on at least one portion of the surface of this molded article. The covering layer may be formed by one layer, or two or more layers. The laminating method is not particularly limited, but an appropriately suitable method can be adopted in view of the shape of the molded article with respect to the intended use. The molded article of the present embodiment is particularly suitable as a material for a relay block or the like because of being excellent in flame retardance and surface appearance.

In the present embodiment, the number average particle size of the component (C) in the molded article can be controlled to thereby impart superior physical properties. For example, from the viewpoint of further enhancing flame retardance of the molded article, the number average particle size of the component (C) in the molded article is preferably 10 to 35 μm, more preferably 10 to 30 μm, further preferably 15 to 30 μm, more preferably 20 to 30 μm. Examples of the method for controlling the number average particle size of the component (C) in the molded article may include a method of adjusting melt-kneading conditions (melt-kneading time, strength, and the like) of the component (C) depending on the number average particle size of the component (C) to be subjected to melt-kneading (before melt-kneading).

Examples of a more specific method for controlling the number average particle size of the component (C) may include, when a twin screw extruder is used, a method of adjusting the addition position of the component (C) (position in a kneading zone, where an inlet is provided, and the like), the number of rotations of the screw and the screw configuration of the twin screw extruder (configuration of a kneading block in a kneading zone, and the like), and the like.

For example, when the number average particle size of the component (C) in the molded article exceeds the upper limit described above, a screw configuration so that a number of rotations of the screw of the twin screw extruder can be increased to exhibit a stronger kneading force (for example, an increase in number of kneading blocks and an increase in number of backward screw kneading blocks of a kneading block part) and the like can be selected to thereby reduce the number average particle size of the component (C). In addition, the loading position of the component (C) to the twin screw extruder can be provided upstream of the kneading zone to control to allow the kneading time to be longer, thereby reducing the number average particle size of the component (C).

On the contrary, when the number average particle size of the component (C) in the molded product is less than the lower limit described above, a screw configuration so that a number of rotations of the screw of the twin screw extruder is reduced to exhibit a weaker kneading force (for example, a reduction in number of kneading block parts and a reduction in number of backward screw kneading blocks of a kneading block part) can be selected to thereby increase the number average particle size of the component (D). In addition, the loading position of the component (C) to the twin screw extruder can be provided downstream of the kneading zone to control to allow the kneading time to be shorter, thereby increasing the number average particle size of the component (C).

### Number Average Particle Size to Component (C) in Molded Article

The method for measuring the number average particle size of the component (C) may include a method in which the molded article is cut by a microtome, an image of the cut surface is taken by a scanning electron microscope, and a dispersing particle of the component (C) is subjected to actual measurement with reference to the image taken, and to analysis by an image analysis apparatus. More specifically, the number average particle size can be determined according to the method described in Examples. A core phase of the molded article is cut by a microtome in the direction perpendicular to the flowing direction, and an area of 0.05 mm² on the cut surface exposed is photographed using a scanning electron microscope (S-3000N manufactured by Hitachi High-Technologies Corporation) at a magnification of 800. The photograph is taken at three points, and the number average particle size is determined using an image analysis apparatus (“LUZEX SE” manufactured by Nireco Corporation) with reference to the respective photographs. Number average particle sizes at three points (measurement subject having a longer diameter of 0.5 μm or more) are determined and the average thereof is defined as “the number average particle size of the component (C) in the molded article” herein.

### EXAMPLE

Hereinafter, the present invention is described with reference to specific Examples and Comparative Examples, but the present invention is not limited thereto. Measurement methods and raw materials used in Examples and Comparative Examples are shown below.

### Measurement Methods of Characteristics

### (1) Flame Retardance (UL-94 Standard)

The method according to UL94 (standard defined by Under Writers Laboratories Inc. in USA) was used to perform the measurement for five pieces per sample. Two types of test pieces were used: a test piece having a length of 127 mm, a width of 12.7 mm and a thickness of 1.5 mm, and a test piece having a length of 127 mm, a width of 12.7 mm and a thickness of 2.0 mm. Each of the test pieces was molded using an injection molding machine (manufactured by TOSHIBA MACHINE CO., LTD.: IS-80EPN).

The preset temperature in molding of the test piece in each of Examples and Comparative Examples is shown below.

### Examples 1, 3 to 9 and Comparative Examples 1 to 5

cyclinder temperature: 300° C., mold temperature: 100° C.

### Example 2

cyclinder temperature: 280° C., mold temperature: 80° C.

### Example 10 and Comparative Example 6

cylinder temperature: 310° C., mold temperature: 100° C.

### Example 11 and Comparative Example 7

cylinder temperature: 250° C., mold temperature: 60° C.

### (2) Melt Volume Flow Rate: MVR

The melt volume flow rate was evaluated under conditions recited in each Table according to ISO 1133 by using the resin composition pellet produced in each of Examples and Comparative Examples.

### (3) Charpy Impact Strength Notched

Each JIS K7139 A-based multi-purpose test piece was molded from the resin composition pellet produced in each of Examples and Comparative Examples by using an injection molding machine (manufactured by TOSHIBA MACHINE CO., LTD., IS-80-EPN). Each test piece was taken out from this multi-purpose test piece, and the Charpy impact strength was evaluated under a temperature condition of 23° C. according to ISO 179.

The preset temperature in molding of the test piece in each of Examples and Comparative Examples is shown below.

### Examples 1 to 10 and Comparative Examples 1 to 6

cyclinder temperature: 290° C., mold temperature: 90° C.

### Example 11 and Comparative Example 7

cylinder temperature: 250° C., mold temperature: 60° C.

### (4) Appearance of Molded Article (Mold Temperature: 80° C.)

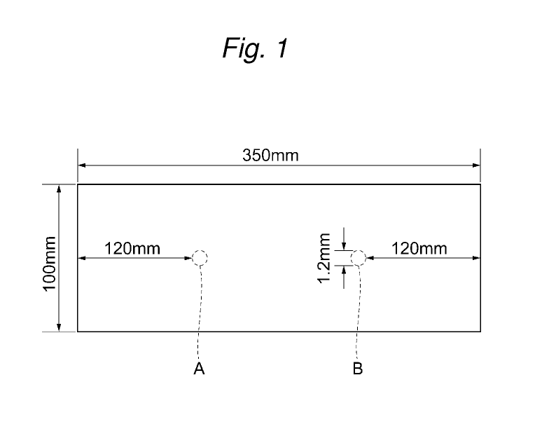

Each flat plate illustrated in FIG. 1 was produced from the resin composition pellet in each of Examples and Comparative Examples under conditions of a cylinder temperature of 290° C. and a mold temperature of 80° C. by using an injection molding machine (SE-130B manufactured by Sumitomo Heavy Industries Ltd.). FIG. 1 illustrates a schematic plan view of a molded article of a resin composition, used for appearance characteristic evaluation. As illustrated in FIG. 1, the flat plate had a size of 350 mm×100 mm×2 mm. In FIG. 1, regions A and B were portions connected to a gate in injection molding, and the gate diameter was 1.2 mmΦ.

The present temperature in molding of the test piece in each of Examples and Comparative Examples is shown below.

### Examples 1 to 10 and Comparative Examples 1 to 6

cylinder temperature: 290° C.

### Example 11 and Comparative Example 7

cylinder temperature: 270° C.

Then, a region (area), in which silver streaks were generated on gate and weld portions in injection molding of the flat plate, was determined. Then, the ratio of the generation region of silver streaks (area ratio: “area of silver streaks generated on gate and weld portions”/“whole surface area of gate and weld portions”) was calculated. Then, the surface appearance of the molded article was evaluated based on the following determination criteria.

### Determination Criteria

Rank 1: the region, in which silver streaks were generated on gate and weld portions, was less than ¼ of the whole surface of the gate portion and the weld portion.
Rank 2: silver streaks were generated in a region of ¼ or more and less than ½ of the whole surface of the gate and the weld portions.
Rank 3: silver streaks were generated in a region of ½ or more and less than ⅔ of the whole surface of the gate and the weld portions.
Rank 4: silver streaks were generated in a region of ⅔ or more of the whole surface of the gate and the weld portions and less than the whole surface.
Rank 5: silver streaks were generated over the whole surface of the gate and the weld portions.

### (5) Appearance of Molded Article (Mold Temperature: 100° C.)

Each flat plate was produced under the same conditions as in those described in the section of “(4) Appearance of molded article (mold temperature: 80° C.)” expect that the mold temperature was set to 100° C., and the appearance thereof was evaluated.

### (6) Content of Iron Element

Each molded article was produced from the resin composition pellet in each of Examples and Comparative Examples by the same method as that of the test piece for evaluation of flame retardance. The surface of the resulting molded article was washed with pure water in a clean room. Thereafter, 0.25 g of the resultant was cut using a nipper coated with titanium, to provide a specimen. The specimen was loaded into a decomposition vessel made of Teflon (registered trademark), sulfuric acid and nitric acid were added thereto, and the resultant was subjected to pressure acid decomposition using a microwave decomposition apparatus. Then, 25 mL of the decomposition liquid was weighed to provide a measurement solution. This measurement solution was subjected to measurement by the absolute calibration method using an ICP mass spectrometer (internal standard: cobalt), for componential analysis. Herein, the measurement of the content of an iron element was performed using a hydrogen gas for a reaction gas in order to prevent the interference due to an argon gas being a plasma gas.

### (7) Number Average Particle Size of Component (C)

Each molded article having a thickness of 1.5 mm was produced from the resin composition pellet produced in each of Examples and Comparative Examples by the same method as that of the test piece for evaluation of flame retardance. A core phase of the central portion of the molded article was cut by a microtome in the direction perpendicular to the flowing direction (extruding direction). An image of an area of 0.05 mm² on the cut surface was taken using a scanning electron microscope (S-3000N manufactured by Hitachi High-Technologies Corporation) at a magnification of 800. The image was taken at three point of the cut surface. The number average particle size of the component (C) in the molded article was determined with reference to the three photographs (measurement subject having a longer diameter of 0.5 μm or more) by using an image analysis apparatus (LUZEX SE manufactured by Nireco Corporation). Specifically, the number average particle size was measured at one point per photograph and the measurement values of the number average particle sizes at three points were obtained. Then, the arithmetic average value of these measurement values was defined as “the number average particle size of the component (C) in the molded article”.

### Materials Used in Examples and Comparative Examples

### (A) Thermoplastic Resin

### Polyamide-Based Resin

### <(A-1) Polyamide 6,6 (Hereinafter, Abbreviated as “PA66”)>

A 5-L autoclave was charged with 2400 g of an equimolar salt of adipic acid and hexamethylenediamine, 100 g of adipic acid, and 2.5 L of pure water, and the content thereof was sufficiently stirred. After the atmosphere in the autoclave was sufficiently replaced with nitrogen, the content of the autoclave was heated with stirring from room temperature to 220° C. over about 1 hour. Here, the gauge pressure in the autoclave was 1.76 MPa in terms of natural pressure of steam. Subsequently, heating was continued with water being removed outside of the reaction system so that the pressure was less than 1.76 MPa. After additional 2 hours, when the inner temperature reached 260° C., the pressure was dropped by opening and closing of a valve of the autoclave over 40 minutes with heating being continued, until the inner pressure reached 0.2 MPa. Thereafter, the resultant was cooled to room temperature over about 8 hours. After the cooling, the autoclave was opened, and about 2 kg of polyamide was taken out and ground.

The viscosity number (measured in 96% sulfuric acid, defined by ISO 307:1997) of the resulting polyamide (PA66) was 199 mL/g. The concentration of the terminal amino group of the polyamide was measured according to the method for measuring the concentration of an amino group terminal, described in Examples of Japanese patent Laid-Open No. 07-228689, and as a result, was 38 μmol/g.

### <(A-2) Polyamide 6,6/6I (Hereinafter, Abbreviated as “PA66/6I”)>

A 5-L autoclave was charged with 2.00 kg of an equimolar salt of adipic acid and hexamethylenediamine, 0.50 kg of an equimolar salt of isophthalic acid and hexamethylenediamine, and 2.5 kg of pure water, and the content thereof was sufficiently stirred. After the atmosphere in the autoclave was sufficiently replaced with nitrogen, the content of the autoclave was heated with stirring from room temperature to 220° C. over about 1 hour. Here, while the inner pressure in the autoclave was 1.76 MPa in terms of natural pressure of steam, heating was further continued with water being removed outside of the reaction system so that the pressure was less than 1.76 MPa or more. After additional 2 hours, when the inner temperature reached 260° C., heating was stopped, a discharge valve of the autoclave was turned off, and the resultant was cooled to room temperature over about 8 hours. After the cooling, the autoclave was opened, and about 2 kg of polyamide was taken out and ground.

The resulting polyamide ground was loaded in a 10-L evaporator, and subjected to solid phase polymerization under a N2 stream at 200° C. for 10 hours. The viscosity number (measured in 96% sulfuric acid, defined by ISO 307:1997) of the resulting polyamide (PA66/6I) was 91 ml/g. In addition, the concentration of the terminal amino group was measured according to the method for measuring the concentration of an amino group terminal, described in Examples of Japanese Patent Laid-Open No. 7-228689, and as a result, the concentration of the terminal amino group was 48 μmol/g.

### Polystyrene-Based Resin

### <(A-3) High Impact Polystyrene (Hereinafter, Abbreviated as “HIPS”)>

Trade name “PSJpolystyrene H9302”, produced by PS Japan Corporation

### <(A-4) Homopolystyrene (Hereinafter, Abbreviated as GPPS)>

Trade name “PSJpolystyrene685”, produced by PS Japan Corporation

### <(A-5) Polypropylene>

Polypropylene homopolymer (MFR=6 g/10 min)

Herein, the MFR of the polypropylene resin was measured according to ISO 1133 under conditions of 230° C. and a load of 2.16 kg.

### (B) Polyphenylene Ether (Hereinafter, Abbreviated as PPE)

### <(B-1)>

PPE was prepared according to the method described in Comparative Example 1 of International Publication No. 2011/105504 except that electromagnetic separation was not performed. Herein, the reduction treatment of the content of an iron element was assumed not to be performed, and the separation operation by electromagnetic separation was not performed.

The reduced viscosity of this PPE was 0.52 dL/g (0.5 g/dL, measured in chloroform solution at 30° C.), and the iron content in the PPE was 1.2 ppm.

### <(B-2)>

PPE was prepared according to the method described in Example 1 of International Publication No. 2011/105504. Specifically, PPE was prepared by the following method. While a nitrogen gas was blown at a flow rate of 13 NL/min into a 2000-L jacketed stainless polymerization tank equipped with an iron sparger for oxygen-containing gas introduction, a stainless stirring turbine blade and a stainless baffle at the bottom of the polymerization tank, and equipped with a reflux condenser in a vent gas line at the upper portion of the polymerization tank, 160.8 g of cupric oxide, 1209.0 g of an aqueous 47% hydrogen bromide solution, 387.36 g of di-t-butylethylenediamine, 1875.2 g of di-n-butylamine, 5707.2 g of butyldimethylamine, 826 kg of toluene and 124.8 kg of 2,6-dimethylphenol were loaded thereto to provide a uniform solution, and the uniform solution was stirred until the inner temperature of a reactor reached 25° C.

Then, dry air was started to be introduced to the polymerization tank at a rate of 1312 NL/min by the sparger, and polymerization was started. Air-blowing was performed for 142 minutes to control the inner temperature at the terminal of polymerization to 40° C.

The polymerization liquid at the terminal of polymerization was in the form of a solution.

The blowing of dry air was stopped, 100 kg of an aqueous 2.5% by mass solution of a tetrasodium ethylenediaminetetraacetate salt (produced by Dojindo Molecular Technologies, Inc.) was added to a polymerization mixture, and the polymerization mixture was stirred at 70° C. for 150 minutes, then left to still stand, and separated to an organic phase and an aqueous phase by liquid-liquid separation (disc type centrifuge machine manufactured by GEA).

After the resulting organic phase was cooled to room temperature, excessive methanol was added thereto to prepare a slurry in which polyphenylene ether was precipitated. Thereafter, Basket Centre (0-15 type manufactured by TANABE WILLTEC INC) was used for filtering. After the filtering, excessive methanol was loaded into Basket Centre, and filtering was performed again to provide wet polyphenylene ether. Then, the wet polyphenylene ether was loaded to a feather mill (“EM-1S” manufactured by Hosokawa Micron), in which a round hole mesh of 10 mm was disposed, ground, and then held using a conical dryer at 150° C. and 1 mmHg for 1.5 hours, to provide a dry polyphenylene ether powder.

This powder was subjected to a separation operation using an electromagnetic separator (trade name “CG-180X type”) manufactured by Nippon Magnetics, Inc. This powder was allowed to pass through a bar screen (aperture 5 mm×20 sheets) at a magnetic flux density of 1.6 T and at a speed of about 200 kg/hour. The reduced viscosity of this PPE was 0.52 dL/g (0.5 g/dL, measured in chloroform solution at 30° C.), and the content of a magnetic metal in the PPE was 0.002 ppm.

### <(B-3)>

The amount of air blown in polymerization was changed to 100 minutes. Other conditions were the same as those in (B-2), to produce PPE. The reduced viscosity of the PPE was 0.33 dL/g, and the content of a magnetic metal in the PPE was 0.005 ppm.

### (C) Phosphinates

### <(C-1) Phosphinates>

Trade name “Exolit (registered trademark) OP1230” (phosphinic acid aluminum salt) produced by Clariant

### <(C-2) Phosphinates>

“Exolit (registered trademark) OP1312” (phosphinic acid aluminum salt-containing mixture) produced by Clariant

### (D) Colorant

### <(D-1) Black Pigment (Main Component: Carbon Black)>

Trade name “#960” produced by Mitsubishi Chemical Corporation, average primary particle size: 16 mg, amount of DBP absorbed: 64 mL/100 g

### <(D-2) Conductive Carbon Black Master Pellet>

A twin screw extruder (apparatus name “ZSK-25”, manufactured by Werner & Pfleiderer (Germany)) was used, the extruder having hone first supply port provided upstream thereof and one second supply port provided downstream thereof. The temperature of a region from the first supply port to a die was set to 270° C.

Ninety parts by mass of polyamide (A-1) was supplied from the first supply port and molten, thereafter 10 parts by mass of conductive carbon black (“Ketjen Black EC600JD” produced by Ketjen Black International Co.) was supplied from the second supply port, and the resultant was melt-kneaded. Thereafter, a strand exiting from the tip of the die was allowed to pass through a strand bath filled with water for cooling (iron concentration: less than 0.3 ppm), and cooled. Thereafter, the strand was out by a strand cutter to provide a conductive carbon black master pellet.

### <(D-3) Organic Black Coloring Dye>

Trade name “NUBIAN BLACK TN-870” (Solvent Black 7) produced by Orient Chemical Industries Co., Ltd.

### <(D-4) White Pigment 1 (Main Component: Zinc Sulfide)>

Trade name “Sachtolith HD” produced by SCETI K.K.

### <(D-5) White Pigment 2 (Main Component: Titanium Oxide)>

Trade name “Tioxide R-TC30” produced by Huntsman International LLC

### <(D-6) White Pigment 3: Talc>

Trade name “TALCAN PAWDER PK-C” produced by Hayashi Kasei Co., ltd.

### <(D-7) Red Pigment (Main Component: Iron Oxide)>

Trade name “Colortherm Red 110M” produced by Lanxess

### (E) Compatibilizing Agent

### <(E-1) Compatibilizing Agent 1>

Maleic anhydride (special grade reagent) produced by Wako Pure Chemical Industries, Ltd.

### <(E-2) Compatibilizing Agent 2>

Hydrogenated block copolymer having a styrene-hydrogenated butadiene-styrene structure (a-b-a type). The amount of a bound styrene was 43%, the amount of the 1,2-vinyl bond of the polybutadiene moiety was 75%, the number average molecular weight of the polystyrene chain was 20000, and the rate of hydrogenation of the polybutadiene moiety was 99.9%.

The hydrogenated block copolymer was obtained as follows: styrene and butadiene was subjected to anionic block copolymerization in a cyclohexane solvent by using lithium n-butyl as an initiator, and tetrahydrofuran as an agent of modulating the amount of the 1,2-vinyl bond, thereby providing a styrene-butadiene-based block copolymer. Then, bis (η5-cyclopentadienyl)titanium dichloride and lithium n-butyl were used as hydrogenation catalysts to hydrogenate the resulting styrene-butadiene-based block copolymer under conditions of a hydrogen pressure of 5 kg/cm² and a temperature of 50° C. Herein, a polymer structure was controlled by adjusting the amounts and the order of the monomers loaded. The molecular weight was controlled by adjusting the amounts of the catalysts. The amount of the 1,2-vinyl bond was controlled by adjusting the amount of the agent of modulating the amount of the 1,2-vinyl bond, added, and the polymerization temperature. The rate of hydrogenation was controlled by adjusting the hydrogenation time.

The amount of the 1,2-vinyl bond of the polybutadiene moiety was measured by an infrared spectrophotometer, and calculated according to the method described in Analytical Chemistry, Volume 21, No. 8, August 1949. The amount of the bound styrene was measured by an ultraviolet spectrophotometer.

The number average molecular weight of the polystyrene chain was measured by GPC (mobile phase: chloroform, standard substance: polystyrene). The rate of hydrogenation of the polybutadiene moiety was measured by a nuclear magnetic resonance apparatus (NMR).

### (F) Component

### <(F-1) Component>

A copolymer (SEBS) having the following physical properties and including respective blocks: hydrogenated styrene-butadiene-styrene; was used.

Number average molecular weight=246000
Total content of styrene components=33% by mass
Content of 1,2-vinyl=33%
Rate of hydrogenation of polybutadiene moiety=98% or more

The number average molecular weight of the block copolymer was measured under the following conditions using a gel permeation chromatography (GPC) measurement apparatus (“GPC SYSTEM21” manufactured by Showa Denko K.K.) and an ultraviolet spectrometric detector (“UV-41” manufactured by Showa Denko K.K.), and calculated in terms of standard polystyrene.

The measurement conditions of GPC were as follows: Solvent: chloroform, Temperature: 40° C., Column: sample side (“K-G”, “K-800RL”, “K-800R”), reference side (“K-805L”×2 columns), Flow rate: 10 mL/min, Measurement wavelength: 254 nm, Pressure: 15 to 17 kg/cm²

### <(F-2) Component>

A copolymer (SEBS) having the following physical properties and including respective blocks: hydrogenated styrene-butadiene-styrene; was used.

Number average molecular weight=96000
Total content of styrene components=29% by mass
Content of 1,2-vinyl=33%
Rate of hydrogenation of polybutadiene moiety=98% or more

Herein, the measurement conditions of the number average molecular weight were according to the method described in (F-1).

### Other Components

Copper iodide (CuI), reagent produced by Wako Pure Chemical Industries, Ltd.

Potassium iodide (KI), reagent produced by Wako Pure Chemical Industries, Ltd.

### Examples 1 to 5, 7 and 8, and Comparative Example 1, 3 to 5

A twin screw extruder (“ZSK-26MC” manufactured by Coperion GmbH (Germany)) having three supply ports: a supply port at the upstream side, a central supply port and a supply port at the downstream side; was used. The position at which each of the supply ports was disposed was as follows: when the total length of the cylinder of the extruder was assumed to be 1.0, the upstream supply port was provided at a position of L=0 from the upstream side, the central supply port was provided at a position of L=0.4 from the upstream side, and the downstream supply port was provided at a position of L=0.6 from the upstream side. Then, the temperature of the zone from the upstream supply port to the central supply port was set to 320° C., and the temperature of the zone downstream of the central supply port was set to 280° C.

Herein, the number of rotations of the screw of the extruder was controlled to 300 rpm, and the amount ejected was controlled to 15 kg/h. One opening was provided on a block immediately before the cylinder block on which the central supply port was located, one opening was provided on the cylinder block immediately before the die, and the remaining volatile content and oligomer were removed through the respective openings by vacuum suction. Here, the degree of vacuum (absolute pressure) was controlled to 60 Torr.

Under the conditions recited in Table below, raw materials were supplied to the extruder, melt-kneaded, and extruded from the die. The strand extruded from the tip of the die of the extruder was allowed to pass through a strand bath charged with water for cooling (made of SUS, iron concentration: less than 0.3 ppm, on a mass basis) under a condition of an immersion length of 30 cm, to be thereby cooled. Thereafter, the strand was cut using a strand cutter to provide a pellet. In order to control the water content of the resulting pellet, the resulting pellet was left to still stand in a dehumidification dryer set at 80° C. for 1 hour, dried, and then placed in a moisture-proof bag coated with aluminum. The water content of the resulting pellet was controlled to about 200 to 300 ppm.

The resulting resin composition pellet was subjected to the above respective evaluations. The results are shown in Table below.

### Example 6

A resin composition pellet was produced by the same method as in Example 3 expect that the strand extruded from the tip of the die of the extruder was allowed to pass through a strand bath charged with water for cooling (iron concentration: 50 ppm, on a mass basis) under a condition of an immersion length of 60 cm, to be thereby cooled, and was subjected to evaluations. The evaluation results are shown in Table 1.

### Comparative Example 2

Raw materials were supplied under conditions recited in Table 1 and melt-kneaded to thereby provide a resin composition pellet. Then, the strand extruded from the tip of the die of the extruder was allowed to pass through a strand bath charged with water for cooling (iron concentration: 150 ppm, on a mass basis) under a condition of an immersion length of 200 cm, to be thereby cooled. A resin composition pellet was produced by the same method as in Example 3 except that these conditions were adopted, and was subjected to evaluations. The evaluation results are shown in Table 1.

### Example 10 and Comparative Example 6

A twin screw extruder (“ZSK-26MC” manufactured by Coperion GmbH) having a supply port at an upstream side, and two supply ports at the center (first central supply port and second central supply port) was used. The position at which each of the supply ports was provided was as follows: when the total length of the cylinder of the extruder was assumed to be 1.0, the upstream supply port was provided at a position of L=0 from the upstream side, and the first central supply port and the second central supply port were provided at a position of L=0.4 from the upstream side. Then, the temperature of the zone from the upstream supply port to the first and second central supply ports was set to 310° C., and the temperature of the zone downstream of the first and second central supply ports was set to 280° C.

Herein, the number of rotations of the screw of the extruder was controlled to 300 rpm, and the amount ejected was controlled to 15 kg/h. One opening was provided on a block immediately before the cylinder block on which the first and second central supply ports were located, one opening was provided on the cylinder block immediately before the die, and the remaining volatile content and oligomer were removed through the respective openings by vacuum suction. Here, the degree of vacuum (absolute pressure) was controlled to 60 Torr.

Under the conditions recited in Table below, raw materials were supplied to the extruder, melt-kneaded, and extruded from the die. The strand extruded from the tip of the die of the extruder was allowed to pass through a strand bath charged with water for cooling (made of SUS, iron concentration: less than 0.3 ppm, on a mass basis) under a condition of an immersion length of 50 cm, to be thereby cooled. Thereafter, the strand was cut using a strand cutter to provide a pellet.

The resulting resin composition pellet was used and subjected to the above respective evaluations. The results are shown in Table below.

### Example 11 and Comparative Example 7

A twin screw extruder (“ZSK-26MC” manufactured by Coperion GmbH) having three supply ports: a supply port at the upstream side, a central supply port and a supply port at the downstream side; was used. The position at which each of the supply ports was provided was as follows: when the total length of the cylinder of the extruder was assumed to be 1.0, the upstream supply port was provided at a position of L=0 from the upstream side, the central supply port was provided at a position of L=0.4 from the upstream side, and the downstream supply port was provided at a position of L=0.6 from the upstream side. Then, the temperature of the zone from the upstream supply port to the central supply port was set to 320° C., and the temperature of the zone downstream of the central supply port was set to 270° C.

Herein, the number of rotations of the screw of the extruder was controlled to 300 rpm, and the amount ejected was controlled to 15 kg/h. One opening was provided on a block immediately before the cylinder block on which the central supply port was located, one opening was provided on the cylinder block immediately before the die, and the remaining volatile content and oligomer were removed through the respective openings by vacuum suction. Here, the degree of vacuum (absolute pressure) was controlled to 60 Torr.

Under the conditions recited in Table below, raw materials were supplied to the extruder, melt-kneaded, and extruded from the die. The strand extruded from the tip of the die of the extruder was allowed to pass through a strand bath charged with water for cooling (made of SUS, iron concentration: less than 0.3 ppm, on a mass basis) under a condition of an immersion length of 50 cm, to be thereby cooled. Thereafter, the strand was cut using a strand cutter to provide a pellet.

In order to adjust the water content of the resulting resin composition pellet, the resulting resin composition pellet was extruded, then dried in a dehumidification dryer set at 80° c. for 1 hour, and then placed in a moisture-proof bag coated with aluminum to control the water content to less than 500 ppm.

The resulting pellet was used and subjected to the above respective evaluations. The results are shown in Table below.

TABLE 1

| | | | | | | | | | | | | Compar- | Compar- | Compar- | Compar- | Compar- |
|---|---|---|---|---|---|---|---|---|---|---|---|---|---|---|---|---|
| | | | | | | | | | | | | ative | ative | ative | ative | ative |
| | | | Example | Example | Example | Example | Example | Example | Example | Example | Example | Example | Example | Example | Example | Example |
| | | (Unit) | 1 | 2 | 3 | 4 | 5 | 6 | 7 | 8 | 9 | 1 | 2 | 3 | 4 | 5 |
| Compounding | Upstream supply port-1 | | | | | | | | | | | | | | | |
| | B-1 | (parts by mass) | | | | | | | | | | 30 | 30 | | | |
| | B-2 | (parts by mass) | 30 | 30 | 30 | 30 | 30 | 30 | | 30 | 30 | | | 30 | 30 | 30 |
| | B-3 | (parts by mass) | | | | | | | 30 | | | | | | | |
| | C-1 | (parts by mass) | | | | | | | | | 6 | | | | | |
| | Upstream supply port-2 | | | | | | | | | | | | | | | |
| | F-1 | (parts by mass) | 7 | 7 | 7 | 7 | 7 | 7 | 7 | | 7 | 7 | 7 | 7 | 7 | 7 |
| | F-2 | (parts by mass) | | | | | | | | 7 | | | | | | |
| | E-1 | (parts by mass) | 0.16 | 0.16 | 0.16 | 0.16 | 0.16 | 0.16 | 0.16 | 0.16 | 0.16 | 0.16 | 0.16 | 0.16 | 0.16 | 0.16 |
| | Central supply port-1 | | | | | | | | | | | | | | | |
| | A-1 | (parts by mass) | 62 | | 62 | 62 | 62 | 62 | 62 | 62 | 62 | 62 | 62 | 44 | 62 | 62 |
| | A-2 | (parts by mass) | | 62 | | | | | | | | | | | | |
| | D-1 | (parts by mass) | 0.3 | 0.3 | 1.5 | | 0.1 | 1.5 | 0.3 | 0.3 | 0.3 | | 0.3 | | | |
| | D-2 | (parts by mass) | | | | | | | | | | | | 20 | | |
| | D-3 | (parts by mass) | | | | | 0.25 | | | | | | | | | |
| | D-4 | (parts by mass) | | | | 3 | | | | | | | | | | |
| | D-5 | (parts by mass) | | | | | | | | | | | | | 3 | |
| | D-6 | (parts by mass) | | | | | | | | | | | | | | 3 |
| | D-7 | (parts by mass) | | | | | | | | | | 0.1 | | | | |
| | CuI | (parts by mass) | 0.035 | 0.035 | 0.035 | 0.035 | 0.035 | 0.035 | 0.035 | 0.035 | 0.035 | 0.035 | 0.035 | 0.035 | 0.035 | 0.035 |
| | KI | (parts by mass) | 0.15 | 0.15 | 0.15 | 0.15 | 0.15 | 0.15 | 0.15 | 0.15 | 0.15 | 0.15 | 0.15 | 0.15 | 0.15 | 0.15 |
| | Downstream supply port-2 | | | | | | | | | | | | | | | |
| | C-1 | (parts by mass) | 6 | 6 | 8 | 6 | 6 | 6 | 6 | 6 | | 6 | 6 | 6 | 8 | 8 |
| | | | 105.6 | 105.6 | 106.8 | 108.3 | 105.7 | 106.8 | 105.6 | 105.6 | 105.8 | 105.4 | 105.6 | 107.3 | 110.3 | 111.2 |
| Evaluation | Amount of iron element | (ppm) | 7 | 8 | 16 | 8 | 4 | 35 | 8 | 8 | 8 | >500 | 55 | 60 | 80 | 55 |
| results | Flame retardance (1.5 mm) | — | V-0 | V-0 | V-0 | V-0 | V-0 | V-1 | V-1 | V-1 | V-1 | V-1 | V-0 | V-0 | V-0 | V-1 |
| | Flame retardance (2.0 mm) | — | V-0 | V-0 | V-0 | V-0 | V-0 | V-0 | V-0 | V-0 | V-0 | V-1 | V-0 | V-0 | V-0 | V-0 |
| | Molded article appearance | — | 2 | 2 | 3 | 2 | 1 | 3 | 1 | 2 | 2 | 5 | 4 | 4 | 4 | 4 |
| | (mold temperature 80° C.) | | | | | | | | | | | | | | | |
| | Molded article appearance | — | 1 | 1 | 2 | 1 | 1 | 2 | 2 | 1 | 3 | 4 | 3 | 3 | 3 | 3 |
| | (mold temperature 100° C.) | | | | | | | | | | | | | | | |
| | Number of average particle | | 23 | 22 | 24 | 22 | 21 | 23 | 26 | 20 | 8 | 23 | 25 | 22 | 24 | 22 |
| | size of componenet (C) in | | | | | | | | | | | | | | | |
| | molded article | | | | | | | | | | | | | | | |
| | Melt volume flow rate | (cm³/10 min) | 24 | 29 | 25 | 22 | 25 | 28 | 22 | 25 | 18 | 22 | 23 | 18 | 20 | 25 |
| | (280° C., 2.16 kg load) | | | | | | | | | | | | | | | |
| | Charpy impact strength | (kJ/m²) | 9 | 7 | 5 | 6 | 10 | 5 | 6 | 8 | 8 | 8 | 9 | 4 | 4 | 4 |
| | notched | | | | | | | | | | | | | | | |

TABLE 2

| | | | | Comparative |
|---|---|---|---|---|
| | | (Unit) | Example 10 | Example 6 |
| Compounding | Upstream supply port-1 | | | |
| | B-2 | (parts by mass) | 63 | 63 |
| | D-1 | (parts by mass) | 0.3 | |
| | D-7 | (parts by mass) | | 0.3 |
| | Upstream supply port-2 | | | |
| | A-3 | (parts by mass) | 28 | 28 |
| | A-4 | (parts by mass) | 9 | 9 |
| | Central supply port-1 | | | |
| | C-1 | (parts by mass) | 18 | 18 |
| | | | 118.3 | 118.3 |
| Evaluation | Amount of iron element | (ppm) | 9 | >500 |
| results | Flame retardance (1.5 mm) | — | V-0 | V-1 |
| | Flame retardance (2.0 mm) | — | V-0 | V-1 |
| | Molded article appearance | — | 3 | 5 |
| | (mold temperature 80° C.) | | | |
| | Molded article appearance | — | 2 | 4 |
| | (mold temperature 100° C.) | | | |
| | Number average particle size | | 15 | 17 |
| | of component (C) in molded | | | |
| | article | | | |
| | Melt volume flow rate | (cm³/10 min) | 15 | 13 |
| | [280° C., 10 kg load] | | | |
| | Charpy impact strength notched | (kJ/m²) | 7 | 6 |

TABLE 3

| | | | | Comparative |
|---|---|---|---|---|
| | | (Unit) | Example 11 | Example 7 |
| Compounding | Upstream supply port-1 | | | |
| | B-3 | (parts by mass) | 40 | 40 |
| | Upstream supply port-2 | | | |
| | A-5 | (parts by mass) | 10 | 10 |
| | E-2 | (parts by mass) | 10 | 10 |
| | D-4 | (parts by mass) | 3 | |
| | D-5 | (parts by mass) | | 3 |
| | Central supply port-1 | | | |
| | A-5 | (parts by mass) | 50 | 50 |
| | Downstream supply port-2 | | | |
| | C-2 | (parts by mass) | 26 | 26 |
| | | | 139.0 | 139.0 |
| Evaluation | Amount of iron element | (ppm) | 6 | 75 |
| results | Flame retardance (1.5 mm) | — | V-0 | V-1 |
| | Flame retardance (2.0 mm) | — | V-0 | V-0 |
| | Molded article appearance | — | 2 | 4 |
| | (mold temperature 80° C.) | | | |
| | Molded article appearance | — | 1 | 3 |
| | (mold temperature 100° C.) | | | |
| | Number average particle size | | 25 | 17 |
| | of component (C) in molded | | | |
| | article | | | |
| | Melt volume flow rate | (cm³/10 min) | 14 | 13 |
| | [280° C., 10 kg load] | | | |
| | Charpy impact strength notched | (kJ/m²) | 4 | 6 |

From the foregoing, it has been at least confirmed that in each of Examples, flame retardance, molded article appearance, molding fluidity and impact resistance can be maintained in a well-balanced manner at a high level and excellent physical properties are achieved. It is to be noted that in each of Examples 1 to 11, not only generation of silver streaks can be sufficiently suppressed in practice in the above molded article appearance evaluation, but also whitening and mold deposit of the surface appearance of the molded article can also be sufficiently suppressed in practice with no gas being excessively generated in molding. On the other hand, it has been at least confirmed that in each of Comparative Examples, at least any one of flame retardance, molded article appearance, molding fluidity and impact resistance is poor.

The present application is based on Japanese Patent Application (Japanese Patent Application No. 2013-239931) filed with Japan Patent Office on Nov. 20, 2013, the content of which is herein incorporated by reference.

### INDUSTRIAL APPLICABILITY

The flame-retardant thermoplastic resin composition of the present invention has industrial applicability for electric and electronic components such as a connector, a breaker and a magnetic switch, electric components in the automobile field, typified by a relay block, and components in airplanes.

### REFERENCE SIGNS LIST

A, B . . . region

1. A flame-retardant thermoplastic resin composition comprising:
(A) at least one thermoplastic resin selected from a polystyrene-based resin, a polyolefin-based resin, a polyester-based resin, a polyamide-based resin, polyarylene sulfide, polyarylate, polyethersulfone, polyetherimide, polysulfone, polyarylketone and mixtures thereof;
(B) polyphenylene ether;
(C) at least one phosphinate selected from the group consisting of a phosphinate represented by the following general formula (I), a diphosphinate represented by the following general formula (II), and a condensate thereof; and
(D) at least one colorant selected from the group consisting of an organic pigment, an inorganic pigment and an organic dye;
wherein a content of an iron element is less than 50 ppm on a mass basis: 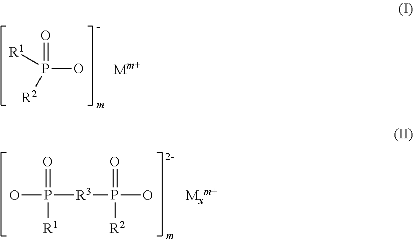
wherein R¹ and R² each independently represent any selected from the group consisting of a straight or branched alkyl group having 1 to 6 carbon atoms, an aryl group and a phenyl group, R³ represents any selected from the group consisting of a straight or branched alkylene group having 1 to 10 carbon atoms, an arylene group having 6 to 10 carbon atoms, an alkylarylene group having 7 to 11 carbon atoms and an arylalkylene group having 8 to 12 carbon atoms, each M independently represents any selected from the group consisting of a calcium ion, a magnesium ion, an aluminum ion, a zinc ion, a bismuth ion, a manganese ion, a sodium ion, a potassium ion and a protonated nitrogen base, each m independently represents 2 or 3, n represents an integer of 1 to 3, and x represents 1 or 2.

2. The flame-retardant thermoplastic resin composition according to claim 1, wherein
the component (D) is carbon black, and
a content of the carbon black in the flame-retardant thermoplastic resin composition is from 0.01 to 2% by mass.

3. The flame-retardant thermoplastic resin composition according to claim 1, wherein the content of an iron element in the flame-retardant thermoplastic resin composition is less than 30 ppm on a mass basis.

4. The flame-retardant thermoplastic resin composition according to claim 1, wherein
the component (A) is at least one selected from a polyolefin-based resin, a polyester-based resin, a polyamide-based resin, polyarylene sulfide, polyetherimide, polyethersulfone, polysulfone, polyarylketone and mixtures thereof, and
the composition further comprises (E) a compatibilizing agent of the component (A) and the component (B).

5. The flame-retardant thermoplastic resin composition according to claim 1, wherein the component (A) is a polyamide-based resin.

6. The flame-retardant thermoplastic resin composition according to claim 5, wherein a content of the component (A) is from 25 to 60% by mass based on a total amount of 100% by mass of the component (A) and the component (B).

7. The flame-retardant thermoplastic resin composition according to claim 5, wherein the component (A) comprises a semi-aromatic polyamide.

8. The flame-retardant thermoplastic resin composition according to claim 5, wherein the component (A) is (al) a semi-aromatic polyamide comprising from 70 to 95% by mass of a hexamethylene adipamide unit and from 5 to 30% by mass of a hexamethylene isophthalamide unit.

9. The flame-retardant thermoplastic resin composition according to claim 1, further comprising (F) an impact resistant agent.

10. The flame-retardant thermoplastic resin composition according to claim 9, wherein the component (F) is a block copolymer comprising at least one block mainly having an aromatic vinyl compound and at least one block mainly having a conjugate diene compound, and/or a hydrogenated product of the block copolymer.

11. The flame-retardant thermoplastic resin composition according to claim 10, wherein a number average molecular weight of the component (F) is 150000 or more.

12. The flame-retardant thermoplastic resin composition according to claim 1, wherein a reduced viscosity of the component (B) is 0.35 dL/g or more.

13. The flame-retardant thermoplastic resin composition according to claim 9, wherein
the component (A) is a polyamide-based resin,
the component (E) is maleic anhydride and/or maleic acid, and
the component (F) is a hydrogenated styrene-ethylene-butylene copolymer and/or a hydrogenated styrene-isobutylene-styrene copolymer.

14. The flame-retardant thermoplastic resin composition according to claim 9, wherein
the component (A) is a polystyrene-based resin, and
the component (F) is a hydrogenated styrene-ethylene-butylene copolymer.

15. The flame-retardant thermoplastic resin composition according to claim 9, wherein
the component (A) is a polypropylene-based resin,
the component (E) is a hydrogenated styrene-ethylene-butylene copolymer, and the component (F) is a polyolefin-based elastomer.

16. The flame-retardant thermoplastic resin composition according to claim 9, wherein
the component (A) is polyphenylene sulfide and/or polybutylene terephthalate,
the component (E) is an epoxy group and/or oxazolyl group-containing polystyrene-based polymer, and
the component (F) is a polyolefin-based elastomer.

17. A molded article comprising the flame-retardant thermoplastic resin composition according to claim 1.

18. The molded article according to claim 17, wherein the molded article is a relay block.

19. The molded article according to claim 17, wherein a number average particle size of the component (C) comprised in the molded article is from 10 to 35 μm.

20. The molded article according to claim 18, wherein a number average particle size of the component (C) comprised in the molded article is from 10 to 35 μm.
